(19) United States
(12) Patent Application Publication
(10) Pub. No.: US 2025/0245741 A1
(43) Pub. Date: Jul. 31, 2025

(54) COMPUTER-IMPLEMENTED BUSINESS METHOD FOR BARTERING GROCERIES FOR SILVER AND GOLD WITHOUT BANK AFFILIATION

(71) Applicant: Gregory John Wenkman, Travelers Rest, SC (US)

(72) Inventor: Gregory John Wenkman, Travelers Rest, SC (US)

(73) Assignee: Silver Gold Money LLC, Travelers Rest, SC (US)

(21) Appl. No.: 18/424,833

(22) Filed: Jan. 28, 2024

(51) Int. Cl. G06Q 40/04; G06Q 20/34

(52) U.S. Cl. CPC G06Q 40/04; G06Q 20/341

(57) ABSTRACT

Computer-implemented business method for bartering groceries and other goods for silver and gold between a business and a customer where the business sells groceries and other goods for currency authorized by the Government of the United States of America, or its successor, and where the business also barters groceries and other goods for the customer's silver and gold where a BARTERED VALUE, that is NOT a currency of any Country or Central Bank is determined by the business and agreed to by the customer for their silver and gold, whereafter BARTERED VALUE is assigned by the business, as an intermediate STEP, to a BARTERED VALUE CARD that is electronically linked to the business' closed-loop electronic communications network system where BARTERED VALUE from the BVC is exchanged for groceries and other goods at checkout, where the BARTERED VALUE is NOT exposed to any bank or financial institution during the BARTER TRANSACTION.

### CROSS-REFERENCE TO RELATED APPLICATIONS

The present patent application relates to the applicant's applications: (1) Ser. No. 18/102,748, titled: A METHOD FOR BARTERING SILVER AND GOLD FOR GROCERIES, filed: Jan. 29, 2023 and (2) Ser. No. 18/120,482, titled: A METHOD FOR BARTERING SILVER AND GOLD FOR GROCERIES, filed: Mar. 13, 2023 and (3) Ser. No. 18/127,764, titled: BUSINESS METHOD FOR BARTERING GROCERIES FOR SILVER AND GOLD, filed: Mar. 29, 2023

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### PETITION TO MAKE SPECIAL BASED ON AGE FOR ADVANCEMENT OF EXAMINATION UNDER 37 CFR 1.1.02(C)(1)

Petitions have been granted for applications Ser. Nos. 18/102,748, 18/120,482, 18/27,764, and 18/424,833

### FIELD OF THE INVENTION

The field of the invention is directed to BARTER, BARTERING, and BARTER TRANSACTION (collectively referred to as BARTER TRANSACTION) and the technical improvement thereof, as shown in the present application. BARTER TRANSACTION has for 5,000 years remained unchanged and without TECHNOLOGICAL IMPROVEMENT. There are two (2) reasons why over this 5,000 year period BARTER TRANSACTION has gone from being 100-percent of all TRANSACTIONS for goods and services all the way down to 1-percent of all TRANSACTIONS, today. Reason number (1), for this, is no one has invented, until now, a new way to conduct BARTER TRANSACTION with a “technological improvement” (aka: technical “practical application”), to overcome the PROBLEMS inherent with BARTER, and (2) the usurpation of the world's monetary-system by the “banksters” (aka: “bankers”) where they have, today, replaced BARTER with fake money or debt-based currency that is an I.O.U., in physical (3% of total) or digital form (97% of total) to perform SALES TRANSACTIONS instead of BARTER TRANSACTIONS. Today, 99-percent of all TRANSACTIONS for the exchange of goods and services are SALES TRANSACTION, executed with payment in a Country's debt-based, fiat currency (in physical or digital form) where I.O.U. Notes (aka: “debt in physical or digital form”) are fraudulently traded back and forth as payment-in-full. The field of the invention is further directed to identifying and solving these two significant PROBLEMS: (1) with BARTER TRANSACTIONS, and (2) with circumvention of the corrupt debt-based currency (aka: MONOPOLY MONEY of the United States called Federal Reserve Note currency) to prevent the BARTER TRANSACTION into becoming a SALES TRANSACTION. The applicant has coined a new word or phrase to define this new invention or new process (aka: “method”) of BARTER, BARTERING, and BARTER TRANSACTION which he named: HYBRID-BARTER, or HYBRID-BARTERING, or HYBRID-BARTER TRANSACTION which will revolutionize BARTER, BARTERING, and BARTER TRANSACTION in the future, for the acquisition of groceries and other goods.

A business method patent is a type of utility patent that invents, claims, and protects “a new way [aka: process] of doing business”, never having been done before using technology (aka: “whoever invents or discovers ANY new and useful process, or ANY new and useful improvement thereof may obtain a patent therefor” under 35 U.S.C. 101). The requirement for a “business patent” is that the invention must have “real-world application” and it must offer “concrete, useful, and tangible results” (See United States Court of Appeals for the Federal Circuit Ancora Technologies, Inc. v. HTC America, Inc. Nov. 16, 2018) and be complaint with 35 U.S.C 112(b), 35 U.S.C. 112(pre-AIA), 35 U.S.C. 101, 35 U.S.C. 102, and 35 U.S.C. 103, which the applicant claims the present application meets all of these requirements. The business method must further show, pursuant to MPEP “2106.05(a) Improvements to the Functioning of a Computer or To Any Other Technology or Technical Field [R-07.2022] which states:

“In determining patent eligibility, examiners should consider whether the claim “purport(s) to improve the functioning of the computer itself” or “any other technology or technical field.” Alice Corp. Pty. Ltd. v. CLS Bank Int'l, 573 U.S. 208, 225, 110 USPQ2d 1976, 1984 (2014). This consideration has also been referred to as the search for a technological solution to a technological problem. See e.g., DDR Holdings, LLC. v. Hotels.com, L.P., 773 F.3d 1245, 1257, 113 USPQ2d 1097, 1105 (Fed. Cir. 2014); Amdocs (Israel), Ltd. v. Openet Telecom, Inc., 841 F.3d 1288, 1300-01, 120 USPQ2d 1527, 1537 (Fed. Cir. 2016) or vi. Other meaningful limitations beyond generally linking the use of the judicial exception to a particular technological environment, e.g., an immunization step that integrates an abstract idea of data comparison into a specific process of immunizing that lowers the risk that immunized patients will later develop chronic immune-mediated diseases, as discussed in Classen Immunotherapies Inc. v. Biogen IDEC, 659 F.3d 1057, 1066-68, 100 USPQ2d 1492, 1499-1502 (Fed. Cir. 2011) (see MPEP 2106.05(e)).

The applicant alleges that both a “practical application” and an “inventive concept” can be found in the “claims” pursuant to MPEP 2106.04(D) and 2106.05. In addition to ‘inventing a new and useful process OR a new and useful IMPROVEMENT thereof’ he has discovered a source of a significant BUSINESS PROBLEM, and under “MPEP 2141.02 Difference Between Prior Art and Claimed Invention [R-07.2022]

### IV, APPLICANTS ALLEGING DISCOVERY OF A SOURCE OF A PROBLEM MUST PROVIDE SUBSTANTIATING EVIDENCE.”

Applicants who allege the inventor discovered the source of a problem must provide evidence substantiating the allegation, either by way of affidavits or declarations, or by way of a clear and persuasive assertion in the specification. In re Wiseman, 596 F.2d 1019, 201 USPQ 658 (CCPA 1979).”

### Discovering Source Cause of a Problem is Part of as a Whole Inquiry

A patentable invention may lie in the discovery of the source of a problem even though the remedy may be obvious once the source of the problem is identified. This is part of the ‘subject matter as a whole’ which should always be considered in: determining the obviousness of an invention under 35 U.S.C. § 103. In re Sponnoble, 405 F.2d 578, 585, 160 USPQ 237, 243 (CCPA 1969). However, discovery of the cause of a problem. does not always result in a patentable invention . . . [A] different situation exists where the solution is obvious from prior art which contains the same solution for a similar problem.” in re Wiseman, 596 F.2d 1019, 1022, 201 USPQ 658, 661 (CCPA 1979) (emphasis in original).

Besides providing “clear and persuasive assertion in the specification”, herein, the applicant is filing separately, under this application his Sworn Declaration providing “SUBSTANTIATING EVIDENCE” to the source of the identified PROBLEM(S), in an effort to help the examiner from overlooking this important claimed assertion. The applicant draws attention to: “[A] patentable invention may lie in the discovery of the source of a problem even though the remedy may be obvious once the source of the problem is identified.” The applicant claims there is NO “prior art” even remotely close to the claimed invention. The applicant lays claim to IDENTIFYING THE PROBLEM(S) and the SOURCE OF THE PROBLEM(S) and the SOLUTION TO THE PROBLEM(S) that should NOT be ignored by the examiners. The PROBLEMS the applicant has identified are unquestionably the biggest PROBLEM facing ALL citizens of the United States.

The present invention is also directed to “patent eligible subject matter” under 35 U.S.C.101 as a “process” under Step 1 of the Alice/Mayo Test. However, because the claims may be considered directed, under 35 U.S.C. 101, to “fundamental economic principles or practices” under Step 2A the inventive method may be deemed to be an “abstract idea” under MPEP 2106. However, since the “claims at issue” integrates the “judicial exception” into a “practical application” under Step 2A, Prong 2 the Test should be streamlined and the claimed invention when viewed as a whole is self-evident as being “patent eligible subject matter”. The Test should end there. “If the additional elements in the claim integrate the recited exception into a practical application of the exception, then the claim is not directed to the judicial exception (Step 2A: NO) and thus is eligible at Pathway B. This concludes the eligibility analysis.” (see MPEP 2106.04(d) below).

### 2106.04(d) Integration of a Judicial Exception Into A Practical Application [R-07.2022]

### I. RELEVANT CONSIDERATIONS FOR EVALUATING WHETHER ADDITIONAL ELEMENTS INTEGRATE A JUDICIAL EXCEPTION INTO A PRACTICAL APPLICATION

Limitations the courts have found indicative that an additional element (or combination of elements) may have integrated the exception into a practical application include:

An improvement in the functioning of a computer, or an improvement to other technology or technical field, as discussed in MPEP 2106.04(d)(1) and 2106.05(a).

Applying or using the judicial exception in some other meaningful way beyond generally linking the use of the judicial exception to a particular technological environment, such that the claim as a whole is more than a drafting effort designed to monopolize the exception, as discussed in MPEP 2106.05(e).

MPEP 2106.06(d)(1) states: A claim reciting a judicial exception is not directed to the judicial exception if it also recites additional elements demonstrating that the claim as a whole integrates the exception into a practical application. One way to demonstrate such integration is when the claimed invention improves the functioning of a computer or improves another technology or technical field. The application or use of the judicial exception in this manner meaningfully limits the claim by going beyond generally linking the use of the judicial exception to a particular technological environment, and thus transforms a claim into patent-eligible subject matter. Such claims are eligible at Step 2A because they are not “directed to” the recited judicial exception”, but instead are directed “patent eligible subject matter”.

However, the improvement analysis at Step 2A Prong Two differs in some respects from the improvements analysis at Step 2B. Specifically, the “improvements” analysis in Step 2A determines whether the claim pertains to an improvement to the functioning of a computer or to another technology without reference to what is well-understood, routine, conventional activity. That is, the claimed invention may integrate the judicial exception into a practical application by demonstrating that it improves the relevant existing technology although it may not be an improvement over well-understood, routine, conventional activity. It should be noted that while this consideration is often referred to in an abbreviated manner as the “improvements consideration,” the word “improvements” in the context of this consideration is limited to improvements to the functioning of a computer or any other technology/technical field, whether in Step 2A Prong Two or in Step 2B.” The applicant claims that under MPEP 2106.05(e) “Other Meaningful Limitations” the present invention and it “claims” meet the requires of “Other Meaningful Limitations” because the “claims” involve “a new combination of steps in a process may be patentable even though all the constituents of the combination were well known and in common use before the combination was made”)

### 2106.05(e) Other Meaningful Limitations [R-10.2019]

Diamond v. Diehr, 450 U.S. 175, 188, 209 USPQ2d 1, 9 (1981) (a new combination of steps in a process may be patentable even though all the constituents of the combination were well known and in common use before the combination was made); BASCOM Global Internet Servs. v. AT&T Mobility LLC, 827 F.3d 1341, 1349, 119 USPQ2d 1236, 1242 (Fed. Cir. 2016). It is important to note that, when appropriate, an examiner may explain on the record why the additional elements meaningfully limit the judicial exception.”

However, in the unlikely event the examination goes onto Step 2B the “inventive concept” (aka: “significantly more”), under MPEP 2106.05 shown in the application should prove the overall process (“claims as a whole”) is “patent eligible subject matter” and therefore patent-eligible under 35 U.S.C. 101, the pro se applicant claims.

The applicant claims that under Step 2A, Prong 2 of the Alice/Mayo Test the claims as a whole integrate the judicial exception into a “practical application” and does so while imposing claim limitations such that the ‘claims at issue’ do NOT monopolized the judicial exception. Furthermore, under Step 2B of the Alice/Mayo Test the applicant claims that an “inventive concept” exists in the claims at issue due to an element or combination of elements recited in the claims that are sufficient to ensure that the claims as a whole amounts to “significantly more” than the judicial exception itself without the claims monopolizing the “inventive concept”. The applicant claims that the “inventive concept may be found in the non-conventional and non-generic arrangement of components that are individually well-known and conventional” (see—MPEP 2106.05 below). Also under 2106.05(d) it states: “If the additional element (or combination of elements) is a specific limitation other than what is well-understood, routine and conventional in the field, for instance because it is an unconventional step that confines the claim to a particular useful application of the judicial exception, then this consideration favors eligibility.”. MPEP 2106.05 further states:

### 2106.05 Eligibility Step 2B: Whether a Claim Amounts to Significantly More [R-07.2022]

### I. THE SEARCH FOR AN INVENTIVE CONCEPT

“Conversely, the presence of a non-physical or intangible additional element does not doom the claims, because tangibility is not necessary for eligibility under the Alice/Mayo test. Enfish, LLC v. Microsoft Corp., 822 F.3d 1327, 118 USPQ2d 1684 (Fed. Cir. 2016) (“that the improvement is not defined by reference to ‘physical’ components does not doom the claims”). See also McRO, Inc. v. Bandai Namco Games Am. Inc., 837 F.3d 1299, 1315, 120 USPQ2d 1091, 1102 (Fed. Cir. 2016), (holding that a process producing an intangible result (a sequence of synchronized, animated characters) was eligible because it improved an existing technological process).”

The applicant, furthermore, claims the “intermediate STEP” in the claimed invention of the present computer-implemented method creates and applies intangible BARTERED VALUE (aka: “process producing an intangible result”) that “improves the existing technological process”.

Microsoft Corp., 662 Fed. App'x at 986, the features were not conventional and thus were considered to reflect an improvement to existing technology. In particular, they enabled the claimed table to achieve benefits over conventional databases, such as increased flexibility, faster search times, and smaller memory requirements. Enfish, 822 F.3d at 1337, 118 USPQ2d at 1690. Under MPEP 2106.04(D) INTEGRATION OF A JUDICIAL EXCEPTION INTO A PRACTICAL APPLICATION” is specifically states: “Limitations the courts have found indicative that an additional element (or combination of elements) may have integrated the exception into a practical application include: * An improvement in the functioning of a computer, or an improvement to other technology or technical field, as discussed in MPEP 2106.04(d)(1) and 2106.05 (a).”

The applicant claims that by adding the cited “intermediate STEP” in the BARTER TRANSACTION, as shown in the “claims at issue” of assigning intangible BARTERED VALUE through technology, on a computer-implemented program designed to process BARTERED VALUE on the business' closed-loop electronic communications network system that is NOT exposed to any payment service provider, or bank, or financial institution a technological improvement has been made to “computer networks” allowing BARTER TRANSACTION which improves the “technology” or “technical field” of computer-implemented BARTER TRANSACTION. For the last 5,000 years BARTER TRANSACTION is represented by an immediate exchange of goods and services without the use of money or currency. On the other hand, SALES TRANSACTIONS are defined by the exchange of goods and services with the use of physical or digital currency as an intermediate step, however, in a SALES TRANSACTION currency ((aka: Federal Reserve Note (FRN) currency)) has to be borrowed into existence with interest, which is known as debt-based currency. Every Federal Reserve dollar has to be borrowed into existence! So there is a significant difference between a SALES TRANSACTION, and a BARTER TRANSACTION, and a HYBRID-BARTER TRANSACTION.

35 U.S.C. 103 Conditions for patentability; non-obvious subject matter.

A patent for a claimed invention may not be obtained, notwithstanding that the claimed invention is not identically disclosed as set forth in section 102, if the differences between the claimed invention and the prior art are such that the claimed invention as a whole would have been obvious before the effective filing date of the claimed invention to a person having ordinary skill in the art to which the claimed invention pertains. Patentability shall not be negated by the manner in which the invention was made.

An unbiased PHOSITA would definitely find the claimed invention NOT obvious, particularly since there is NO prior art that is even remotely “identically disclosed” to the present application.

John Maynard Keynes—1919: “Irredeemable currency is a symptom of a great national sickness. It ‘engages all the hidden forces of economic law on the side of destruction which not one man in a million is able to diagnose’”.

The applicant claims that John Maynard Keynes' above statement proves that a PHOSITA would determine “the claimed invention as a whole would” NOT “have been obvious before the effective filing date of the claimed invention to a person having ordinary skill in the art to which the claimed invention pertains”, because Keynes said: “which not one man in a million is able to diagnose”. The applicant claims that a PHOSITA should NOT be “one man in a million”. “PHOSITA from § 103 is an imaginary person, a strictly hypothetical, legal construct. The PHOSITA is the hypothetical construct by which we define the full public knowledge contained in the prior art. Also, the PHOSITA may be described as having ordinary skill, but is not allowed to innovate, only follow conventional wisdom. However, there is a limit to the knowledge attributable to the PHOSITA.”

The FRN currency assigned to a DEBIT CARD, or a GIFT CARD has to be borrowed into existence, and at interest, and cannot be counterfeiting into existence. The BARTERED VALUE, on the other hand, does NOT have to borrowed into existence, nor is it a debt (I.O.U.) instrument like the FRN currency is, nor is it an asset-backed currency. This fact should NOT be ignored by the examiners, nor the PTAB. BARTERED VALUE is NOT a currency all. The definition of CURRENCY is as noted under DEFINITIONS below):

“CURRENCY: a system of money in use in a particular Country, such as the United States of America, where the coins are issued by the United States Government and where the privately-owned Federal Reserve has a monopoly on the physical and digital form of currency, known as Federal Reserve Note (FRN) currency, that are deemed by the U.S. Government to be “legal tender for all debts, public and private”, including taxes, and are identified by $, cash, money, currency, Federal Reserve Note (FRN), or Central Bank Digital Currency (CBDC), where currency 97-percent of all FRN currency is in digital form, today.” Federal Reserve Note currency is an I.O.U. form of debt-money. BARTERED VALUE and FRN currency are NOT “identically disclosed”

The applicant claims it is NOT the electronically activated physical devices used in the “claims” (i.e. computer, magnetic strip card, etc.) that are patentable, but rather the computer-implemented process (aka: method) and “inventive concept” (aka: “significantly more”) produced by a special computer program implemented on a computer to perform the cited inventive method in a specific way that provides a technical solution to a technical problem that is cited in the patent application and “claims” which makes the “patent eligible subject matter” under 35 U.S.C. 101 for patenting. Under 35 U.S.C. 101 which states: “Whoever invents or discovers any new and useful process, machine, manufacture, or composition of matter, or any new and useful improvement thereof, may obtain a patent therefor, subject to the conditions and requirements of this title.” Clearly this means that if the applicant has invented or discovered a new and useful process for BARTER, BARTERING, or BARTER TRANSACTION or any new and useful improvement thereof and therefor he is entitled to a patent, subject to conditions and requirements of 35 U.S.C. 101, 35 U.S.C. 102, and 35 U.S.C. 103. It is undeniable that the present invention has improved BARTER, BARTERING, and BARTER TRANSACTION through technology and the improvement thereof, and therefore under Step 2A-Prong Two the “claims” clearly integrates the judicial exception into a “practical application” that revolutionizes BARTER TRANSACTION, and under Step 2B clearly there is an “inventive concept” that revolutionizes BARTER TRANSACTION into “significantly more”.

There is ONLY one way to overcome the inherent PROBLEM(S) with BARTER, BARTERING, and BARTER TRANSACTION and that is through the TECHNOLOGICAL IMPROVEMENT of the present claimed invention. For the examiner to claim that there is NO “practical application” or there is NO “inventive concept”, in the “claims at issue”, but ONLY the use “generic computer components”, or “insignificant extra solution activity”, or no technological improvement, or to claim that the present invention monopolizes the judicial exception is without merit under the law. The applicant has included the above citations because they are extremely pertinent to the “FIELD OF THE INVENTION” in examining this application.

### BACKGROUND OF THE INVENTION

BARTER, BARTERING, and BARTER TRANSACTIONS for the last 5,000 year has remained unchanged and without TECHNOLOGICAL improvement. As will be shown in this specification for 5,000 years barterers have been exchanging goods and services between themselves without the use of money or currency resulting in a BARTER TRANSACTION. Then came along the banksters, (aka: “bankers”) who have taken over the monetary-systems of the Country's of the world for their pleasure and profit and who invented debt-based currency or money, by adding as an “intermediate Step” to the BARTER TRANSACTION of using debt-based currency or money, which thereafter transformed BARTER TRANSACTION into SALES TRANSACTIONS. Today, 99-percent of all TRANSACTIONS for goods and services use as an “intermediate STEP” where debt-based currency or money is used which results, not in a BARTER TRANSACTION, but rather a SALES TRANSACTION, where currency has to be BORROWED INTO EXISTENCE WITH INTEREST. For the last 80-years the Federal Reserve Note (FRN) currency has been the ‘world's reserve currency’ which is a debt-based currency that has to be borrowed into existence with interest payable to the bankers (aka: “banksters”). There is no alternative, today, for obtaining goods and services, but to undertake either the old-fashion BARTER TRANSACTION or a SALES TRANSACTION. Today there are 180 currencies in the world circulating in 197 country's, where none of them are exchangeable or redeemable for silver or gold, and are debt-based, fiat currencies. In the United States the Federal Reserve Note (FRN currency) is the debt-based currency (in physical or digital form) used in all SALES TRANSACTIONS. Because of the inherent PROBLEM with the age-old BARTER method, and the PROBLEM of the FRN currency soon becoming worthless there needs to be a third (3rd) form to obtaining goods, and most important groceries. This third form of TRANSACTION the applicant calls HYBRID-BARTER TRANSACTION which will revolutionize BARTER especially when the FRN currency hyper-inflates into becoming worthless, like ALL debt-based currency before it have.

First, the applicant identifies the PROBLEM with BARTER, BARTERING, and BARTER TRANSACTION which has remained unchanged for the last 5,000 years, which includes there needs to be a ‘double coincidence of wants’ for barter to occur between two parties, the inability to make deferred payments, lack of common measure value, difficulty in storage, and, which makes the BARTER SYSTEM, or rather BARTER METHOD, archaic and impractical, without a practical application, which is why less than 1-percent of all TRANSACTIONS in the United States, today, are BARTER TRANSACTIONS. The SECOND identified PROBLEM, herein, is that the citizens of the United States have been and are being forced to purchase (aka: BUY) goods and services with the debt-based (I.O.U.) Federal Reserve Note (FRN) currency, in physical or digital form, known as dollars, cash, or $, or MONOPOLY MONEY, since the privately-owned and operated Federal Reserve Banking cartel took control of the U.S. monetary-system from the U.S. Treasury in 1913, and since 1934 has been creating debt-based, I.O.U., FRN currency that has fallen in value by 99-percent, compared to gold, and soon will become worthless, like ever other debt-based currency has in the last 1,000 years, and this is a significant PROBLEM for every citizen of the United States, because they are working for and saving currency that will become completely worthless. In other words, 99-percent of all TRANSACTIONS to acquire goods and services is done through SALES TRANSACTION of good and services with exchanging I.O.U.'s. (aka: DEBT money or currency). The problem is that even if TECHNOLOGY is added to improve BARTER, BARTERING, and BARTER TRANSACTION then there is the PROBLEM how that added TECHNOLOGY is able to circumvent having to use FRN currency during the BARTER TRANSACTION. The present invention identifies an “inventive method” with a “practical application”, as define under MPEP 2106.04(D), which integrates the judicial exception into “patent eligible subject matter” (aka: “The claim as a whole integrates the judicial exception into a practical application, in which case the claim is not directed to a judicial exception (Step 2A: NO) and is eligible at Pathway B. This concludes the eligibility analysis.”)

This NEW method of BARTER TRANSACTION is urgently needed, as soon the citizenry of the United States will find that the FRN currency will be worthless and the bankers (aka: banksters) who own the Federal Reserve will soon force upon the people of the United States their ‘end game’ goal which is their Central Bank Digital Currency (CBDC) that will completely enslave the citizens of the United States. This PROBLEM with the FRN currency the applicant contends is the most serious PROBLEM facing the 330,000,000 citizens of the United States today, without exception. It is vital to note comments made by famous people of the past on this subject to help educate the examiners with knowledge they do not currently possess concerning the BACKGROUND OF THE INVENTION.

John Maynard Keynes—1919: “Irredeemable currency is a symptom of a great national sickness. It ‘engages all the hidden forces of economic law on the side of destruction which not one man in a million is able to diagnose’.

This Specification of the present application identifies these cited technical PROBLEMS, distinctly and definitely, while the claims of the present application identifies, distinctly and definitely, the technical SOLUTION to these identified technical PROBLEMS.

The present invention is directed to an computer-implemented method where a business, that is a retailer or wholesaler, that SELLS groceries and other goods does so in a SALES TRANSACTION for FRN currency in the United States, and where said retailer or wholesaler also BARTERS groceries and other goods for silver an or gold owned or possessed by a customer (aka: “individual”) where they enter into a BARTER TRANSACTION where the business is employing a computer-implemented method programmed to perform an “intermediate STEP(S)” in the BARTER TRANSACTION where BARTERED VALUE, that is NOT FRN currency, or any other currency or money of any Country or Nation, that has been agreed upon by the barterers, is assigned by the business to a BARTERED VALUE CARD (BVC), or a BARTERED VALUE TOKEN (BVT), or a BARTERED VALUE MOBILE DEVICE (BVMD), each having a unique identifying code that is scanned and record into the business' closed-loop electronic communications network system and where the BARTERED VALUE is entered into business' closed-loop electronic communications network system and assigned to the BVC, or BVT, or BVMD and where the computer-implement program does NOT provide any information on the BARTERED VALUE or BARTER TRANSACTION to any payment service provider, or bank, or financial institution, or to the Federal Reserve, and where the computer-implemented method keep the BARTER TRANSACTIONS separate or apart from the SALES TRANSACTIONS.

The present invention is further directed to a “TECHNICAL FIELD” of technical devices that comprises a: (1) electronic communications network (aka: “ethernet” and/or “internet”), connected to, (2) closed-loop electronic communications network system of said business programmed to process a computer-implemented BARTER TRANSACTION according to the claimed invention within the closed-loop network without exposing the BARTER TRANSACTION and or BARTERED VALUE to any payment service provider, or bank, or financial institution, or Federal Reserve Bank, connected to, (a.) at least one electronic Central Processing Unit (CPU) having at least one computer-implemented program, programmed to perform the function of the claimed method, connected to (b.) at least one electronic Point-Of-Service (POS) device, connected to, (c.) at least one electronic printer, connected to, (d.) at least one scanner or card reader device capable of communicating with an electronically activated, (e.) BVC, or BVT, or BVMD, may be connected to, (f.) at least one electronic signature pad device, where these connected electronic devices comprise a “TECHNICAL FIELD” (see DEFINITIONS) of the “inventive method”. The applicant claims that the “inventive method” improves the “TECHNICAL FIELD” or “closed-loop electronic network” because it improves BARTER, BARTERING, and BARTER TRANSACTION by adding a “practical application” (under MPEP 2106) through technology that transforms BARTER, BARTERING, and BARTER TRANSACTIONS to HYBRID-BARTER, or HYBRID-BARTERING, or HYBRID-BARTER TRANSACTION, by make bartering for groceries and other goods for silver and gold a “practical application” and furthermore, through the technological improvements shown in the claims a “practical application” allows circumvention of the corrupt FRN currency during the BARTER TRANSACTION, where processing a technical BARTER TRANSACTION from beginning to end is done so without the use of currency or money of any Country or Nation, including that of the United States. Where this “TECHNICAL FIELD” of technical devices have been used for decades to process only SALES TRANSACTIONS using digital FRN currency in the United States for payment of goods and services using a gift card, prepaid card, debit card, or credit card in the form of a magnetic stripe card, mag-stripe card, proximity card or token, or a RFID card or token, or a smart-chip card, or its equivalent. Every time a TRANSACTION has been made for groceries and other goods in the United States using a gift card, or debit card, or prepaid card at a grocery retailer or wholesaler it been for a SALES TRANSACTION, processed on a business' closed-loop or open-loop electronic communications network system, that each has a gateway to a payment service provider, or bank, or financial institution, so the SALES TRANSACTION can be processed for payment using FRN currency in digital form. Payment service providers, banks, financial institution, or Federal Reserve Banks do not and would not accept BARTERED VALUE, therefore the present computer-implemented method has to have a computer-implemented method that does NOT process BARTERED VALUE outside said business, or expose the BARTERED VALUE and BARTER TRANSACTION to any payment service provider, or bank, or financial institution, or Federal Reserve bank. Furthermore, SALES Transactions and BARTER Transactions of said business have to be programmed by the computer implemented method to function differently, or to keep separate and apart from one another as they are different, and must be reported separately or differently to the Internal Revenue Service (aka: IRS). There is NO prior art showing bartering of goods, using an intermediate STEP in the BARTER TRANSACTION, a BVC or a BVT, or a BVMD, that has been issued or assigned BARTERED VALUE, that is NOT currency or money, on a business' closed-loop electronic communications network system where the BARTERED VALUE is NOT exposed to any payment service provider, bank, or financial institution, or Federal Reserve banking system. The applicant claims there is NO prior art that is remotely close to be “identically disclosed” to the present invention. The applicants previously filed three applications concerning related matter where filed with the USPTO less than one year ago, therefore, these three patent applications CANNOT be used as “prior art”.

Nowhere in any prior art does the prior art “identically disclose” what the present application and it claims-at-issue disclose. The applicant claims that he has invented a new and useful process (aka: “method”) never before been used or described to solved the identified PROBLEM of BARTER and the identified PROBLEM with circumventing the current MONOPOLY MONEY (aka: FRN currency). Prior art showing this claimed invention simply does NOT exist. Caution should be taken by the examiner in trying to create prior art, that purports to be “identically disclosed”, when it clearly is not. Doing so may provide evidence of “bias” on the part of the USPTO, to protect the interests of the Federal Reserve banking cartel that owns and operates the U.S. Government and its entities. For reference, review how Saddam Hussein and Muammar Gaddaffi were assassinated by the U.S. Government's military entity when Hussein and Gaddaffi attempted to circumvent the Federal Reserve currency, by BARTERING their Country's oil for gold, instead of continuing to accept the dying Federal Reserve (PetroDollar) currency.

This claimed invention is historic because it allows both business and individuals to (1) circumvent the dying and corrupt FRN currency, that has already stolen 99-percent of its value (compare with the value of gold) from its holders, and (2) resurrect the BARTER method, but with a TECHNOLOGICAL IMPROVEMENT (aka: HYBRID-BARTER), that incorporates a “practical application” that is “patent subject matter eligible”. See following citation:

“The claimed subject matter must not be wholly directed to a judicially recognized exception. However, a claim that is limited to a particular practical application of a judicially recognized exception is eligible for patent protection. A “practical application” relates to how a judicially recognized exception is applied in a real world product or a process, and not merely to the result achieved by the invention. When subject matter has been reduced to a particular practical application having a real world use, the claimed practical application is evidence that the subject matter is not abstract (e.g., not purely mental) and does not encompass substantially all uses (preemption) of a law of nature or a physical phenomenon. See, e.g., Ultramercial v. Hulu, 657 F.3d 1323, 1329, 100 USPQ2d 1140, 1145 (Fed. Cir. 2011) “Once a practical application has been established, the limited occurrence of preemption must be evaluated to determine whether the claim impermissibly covers substantially all practical applications of the judicially excepted subject matter. If so, the claim is not patent-eligible. If the claim covers only a particular practical application of the judicially excepted subject matter, it is patent eligible.”

It is extremely important for the examiner of the present application to throughly understand the BACKGROUND OF THE INVENTION which requires an in-depth understanding of prior and existing art of barter, money, asset-backed currency, debt-based currency including the Federal Reserve Note (FRN) currency, and Central Bank Digital Currency (CBDC), and SALES TRANSACTIONS vs. BARTER TRANSACTIONS to understand the importance, usefulness, timeliness, inventiveness of the present invention with its “inventive method” having a “practical application” and an “inventive concept” (aka: “significantly more”) which overcomes the PROBLEMS identified by the applicant in these Specification and identifies the SOLUTION to theses identified PROBLEM(S) in the “claims” using “TECHNICAL IMPROVEMENTS” to “improve” “any other technology or technical field”. (see MPEP 2106.04(d)(1) and 2106.05(a)).

From the beginning of human civilization, and for thousands of years thereafter, people relied on barter as a means of exchange of goods and services between two parties. This method proved to be a very inefficient means of exchange for obvious reasons, but there was no alternative at the time since money had not yet been invented. According to historical records, it wasn't until around 650 B.C. in Lydia, now Turkey, that merchants and consumers started using coins struck of a naturally occurring electrum of gold and silver as a medium of exchange, which at some point became known as money. Due to the scarce nature of silver and gold in the earth's crust, these precious metals coins or tokens, have stood the test of time to be an excellent ‘store of value’ as money, and therefore are known to have intrinsic value. The cost of exploration, refining, and minting associated with making silver and or gold coins, tokens, or bars is ‘stored value’ in each coin, or token, or bar, forever.

Money is commonly defined, among economists, as a medium that must possess three distinct qualities or intrinsic elements; money must: (1) be accepted as a means of exchange, (2) be a unit of measure, and (3) be a store of value. The Federal Reserve Bank of St. Louis defines money as: “To summarize, money has taken many forms through the ages, but money consistently has three functions: store of value, unit of account, and medium of exchange.” Over the last 90-years a fourth element has been added to the definition of money, which is money must be authorized by the Government to be “LEGAL TENDER FOR ALL DEBTS PUBLIC AND PRIVATE” including TAXES. Gold has NOT been accepted as payment of TAXES in the United States for the last 90-years, therefore, gold is NOT considered money.

History has shown, all empires begin with money made of gold and silver and end with counterfeit currency. During the height of the Roman Empire their money and currency were a silver coin called Denarius and a gold coin called Aureus. For some time the value was placed on the Aureus coin as being exchangeable money at the rate of 25 Denarius coins. It is believed that the ratio of silver to gold found in the earth's crust is approximately 15.5 to 1. During this time, Rome flourished as a Republic and their Empire grew over hundreds of years, and many historians and economists attribute this to their monetary-system consisting of coins made of silver and or gold.

The fall of the Roman Empire coincided with the counterfeiting of the silver Denarius and the gold Aureus whereby the Roman government diluted the respective silver and gold coin content, slowly over many decades, from more than ninety-percent down to where their coins contained little or no silver or gold and were instead made of bronze using base metals. Once people and merchants realized their goods and services were being exchanged for counterfeit money their monetary-system collapsed, causing the fall of the Roman Empire around 476A.D. This lead to a period, thereafter, in history called the ‘Dark Ages’, which lasted nearly one-thousand years and where Rome's population fell from approximately one million people to less than 50,000, where people vacated the city for the countryside to survive from starvation by growing their own food and where the barter system replaced the failed fiat-currency system. Over time silver and gold coins, having “stored value”, always made their way back into the monetary-system, only to see future corrupt governments counterfeit their currency, time and again.

Due to the fact that it is impractical, because of weight, for individuals to carry large amounts of silver or gold money on their person; banknotes (made of paper and today cotton and linen) became popular over the last several hundred years, and particularly after the invention of the printing press. Banknotes are a warehouse receipts, issued by governments or banks as banknotes or paper promissory notes, known as I.O.U.s, redeemable on demand by the Bearer a certain amount of “LEGAL TENDER”, usually silver or gold coin, when presented to the cashier of the originating bank for redemption.

Countless times, over the last several hundred years, upon the Bearer's demand for his silver or gold back met with the bank's or government's failure due to fraud or default by the bank or government for not having sufficient silver or gold to cover all the issued and outstanding banknotes or promissory notes (I.O.U.s).

In 1729, Voltaire stated: “all paper money eventually returns to its intrinsic value—zero”. History has proven Voltaire to be correct. More precisely: all fiat (meaning decreed by law or government and unbacked by a physical commodity such as gold and silver) currency, in history, over the last 1,000 years, have gone from being worth less to being worthless over time, with the exception being only those currencies that are in the current state of becoming worthless, such as the 90-year old debt-based Federal Reserve Note (FRN) currency.

Between 1865 and 1933 gold certificates or banknotes, or Notes were issued in the United States which were I.O.U.s. A gold certificate, in general, is a certificate or Note (I.O.U.) of ownership by the holder or bearer of the gold certificate is due a specific amount of gold in exchange or redemption for the Note. Between 1878 and 1964 silver certificates were issued in the United States. A silver certificate, in general, is a certificate of ownership of silver by the holder or bearer of the certificate or Note stored by the bank and redeemable by the bearer upon demand. These gold and silvers certificates, or banknotes, or Notes are, once again, nothing more than paper I.O.U. receipts or Notes between the issuing government or private bank and the bearer of the certificates or Notes.

Banker, J.P. Morgan, stated before Congress in 1912: “Gold is money. Everything else is credit”. Credit is in fact nothing more than debt. That statement by J.P. Morgan was made shortly before the corrupt privately-owned banking cartel, known as the Federal Reserve, usurped control of the United States Treasury monetary-system on Dec. 23, 1913 in a coup, the applicant claims.

The Federal Reserve Act of 1913 was purportedly passed by congress and signed into law by President Woodrow Wilson, thereby allowing the newly created and privately-owned and operated Federal Reserve banking cartel to take control of the United States currency or monetary-system from the United States Treasury. Where the Federal Reserve would thereafter create currency or money and then loan it to the U.S. Government with interest, where before the U.S. Government created their own currency and did NOT have to pay interest. In the early years of the Federal Reserve, between 1914 and 1933, it issued vast quantities of gold certificates. It did not take President Wilson long to understand his vast mistake of allowing this corrupt privately-owned corporation to take over the U.S. monetary-system for their own pleasure and profit at the expense of the U.S. citizenry (see following famous quotes).

President Woodrow Wilson, 1916 “I am a most unhappy man. I have unwittingly ruined my country. A great industrial nation is controlled by its system of credit. Our system of credit is concentrated. The growth of the nation, therefore, and all our activities are in the hands of a few men. We have come to be one of the worst ruled, one of the most completely controlled and dominated governments in the civilized world. No longer a government by free opinion, no longer a government by conviction and the vote of the majority, but a government by the opinion and duress of a small group of dominant men.”
President Woodrow Wilson, In the New Freedom 1913—“A great industrial nation is controlled by its system of credit. Our system of credit is concentrated. The growth of the Nation and all our activities are in the hands of a few men. We have come to be one of the worst ruled, one of the most completely controlled and dominated Governments in the world—no longer a Government of free opinion no longer a Government by conviction and vote of the majority, but a Government by the opinion and duress of small groups of dominant men . . . . Since I entered politics, I have chiefly had men's views confided to me privately. Some of the biggest men in the U.S., in the field of commerce and manufacturing, are afraid of somebody, are afraid of something. They know that there is a power somewhere so organized, so subtle, so watchful, so interlocked, so complete, so pervasive, that they had better not speak above their breath when they speak in condemnation of it.”

Money creation by the Federal Reserve was rampant in the 1920's which lead to what was later termed—“The Roaring’20's”. The Federal Reserve knew that as long as their Federal Reserve Note (FRN) currency was back by or redeemable for gold that the U.S. citizens would sooner or later discover the Federal Reserve PONZI scheme of inflating the money supply which ultimately would result in a run on their banks to exchange paper I.O.U. currency for gold, so they knew they had to remove their FRN from being redeemable for gold. After the stage was set, the Federal Reserve in 1929 reduced the money supply, by making “margin calls”, thus causing the stock market collapse of 1929-32, and the subsequent Great Depression, where the Dow Jones stock market fell eighty-nine percent between late 1929 and mid-1932. After 36 hours of becoming President, Roosevelt issued Proclamation 2039, on Mar. 6, 1933, wherein he stated in the first sentence: “Whereas there have been heavy and unwarranted withdrawals of gold and currency from our banking institutions for the purpose of hoarding . . . has resulted in severe drains on the Nation's stocks of gold . . . ”. In this proclamation it ordered the closure of all U.S. banks for several days which they called it a “Banking Holiday”. When the banks were allowed to reopen more than 9,000 banks failed, taking with them the saving of many millions of people totaling $7 billion dollars (source: Social Security Administration(.gov), which lead to the starvation of millions of individuals in the United States during the Great Depression which was concealed from public by their controlled media.

President James Garfield—assassinated after making this statement—“Whomsoever controls the volume of money in any country is absolute master of all industry and commerce and when you realize that the entire system is very easily controlled, one way or another, by a few powerful men at the top, you will not have to be told how periods of inflation and depression originate.”
Boris Borisov, in his article titled—“The American Famine” estimated the victims of the financial crisis in the US at over seven million people. The researcher also directly compared the US events of 1932-1933 with Holodomor, or Famine, in the USSR during 1930-1933 which claimed the lives of several million Russians.

Thirty-three days after President Roosevelt took office he issued, on Apr. 6, 1933 Executive Order 6102 ordering the citizens of the United States to surrender their gold bullion, gold coin, and gold certificates, under penalty of law, by May 1, 1933, not to the U.S. Government or U.S. Treasury, but instead to the privately-owned Federal Reserve banks in exchange for debt-based, fiat-currency of the Federal Reserve Banking cartel, backed by the taxpayers who had just been stripped of their wealth (aka: gold). Executive Order 6102 specifically stated: “UNDER EXECUTIVE ORDER OF THE PRESIDENT all persons are required to deliver all GOLD COIN, GOLD BULLION, AND GOLD CERTIFICATES owned by them to a Federal Reserve Bank, branch, or agency, or to any member bank of the Federal Reserve System.” Foreign citizens were exempt from this Executive Order as well as foreign privately-owned Central Banks and foreign governments who were permitted to rob or drain the United States of this gold that had been confiscated by the Federal Reserve. The foreign Central Banks and foreign governments (especially France) over the next 38 years (from 1934 to 1971) used their Federal Reserve gold back Banknotes holdings to raid and deplete the U.S. Government gold holdings, supposedly held at Fort Knox. On Aug. 15, 1971 President Nixon, through Executive Order 11615 severed completely the last convertibility of the Federal Reserve Note into gold by foreign governments or foreign privately-owned central banks, officially ending the link between the Federal Reserve Note currency and gold, to the present date. Some people claim that the U.S. gold holdings at Fort Knox Gold Depository had been emptied of its gold during this 38 year period and maybe explains why the Federal Reserve and the U.S Government will not allow the supposed gold holdings at Fort Knox to be audited. On Jun. 4, 1963 President John F. Kennedy signed Executive order 11110 authorizing the issuance of $4.3 billion in non-debt based United States Silver Certificates (exchangeable for silver) by the U.S. Treasury which would circumvent the corrupt Federal Reserve banking cartel. Less than 6-months later the President was, like President Abraham Lincoln, shot in the head and assassinated for his actions. President Lincoln had in 1862 also issued $450 million of Debt-Free, Non-interest bearing Notes (I.O.U. notes called “Greenbacks”—because they were printed with green ink on their backside) directly from the U.S.Treasury.

President Abraham Lincoln—“I have two great enemies, the southern army in front of me and the financial institutions in the rear. Of the two, the one in the rear is the greatest enemy. The money power preys upon the nation in times of peace, and conspires against it in times of adversity. It is more despotic than monarchy, more insolent than autocracy, more selfish than bureaucracy. It denounces, as public enemies, all who question its methods or throw light upon its crimes.”

President Johnson, after Kennedy was executed, through his Coinage Act of 1965 demonetized silver from all U.S. coinage, whereafter, U.S. coins were counterfeited and made from base metal slugs, thus ending any gold or silver backing to U.S. currency and coinage. Today, nearly the whole world is on a debt-based, fiat-currency PONZI scheme operated by the privately-owned central banks that are in the hands of few unknown banksters that rule the world and its inhabitants for their pleasure and profit.

People today are unaware that with President Roosevelt's Executive Order 6102 signed on Apr. 6, 1933 which required all citizens to turn in their gold to the Federal Reserve Banks by May 1, 1933 that the government of the United States of America actually went bankrupt as of that date, since the currency of the United States of America issued by the privately-owned and operated Federal Reserve banking cartel after May 1, 1933 no longer had any intrinsic value and became an debt-based I.O.U. and NOT exchangeable for “LEGAL TENDER” which cannot be an I.O.U. The FRN went from being gold-backed currency to being debt-backed (I.O.U) currency where inevitably the currency must fail due to debt that cannot be repaid. People are even less aware that for the last 90-years the U.S. Government has been operating in bankruptcy simply where everyone is simply exchanging I.O.U.'s. Prior to May 1, 1933 “legal tender” money or currency existed where the paper currency NOTES (I.O.U.s) were redeemable for gold, a tangible asset that has no debt. After May 1, 1933 the Federal Reserve Note were only redeemable for itself, an I.O.U., that has over time lost 99-percent of its value when measured against the value of gold today. The United States Government went bankrupt without informing its citizens that it actually went bankrupt after defaulting on its obligation to exchange the Federal Reserve Note (FRN) for “legal tender” that being gold. For the last 90 years the citizens of the bankrupt United States of America have been trading amongst themselves I.O.U.s which are nothing more debt or today an electronic debt instruments which represents a giant PONZI scheme formulated by the corrupt Federal Reserve banking cartel for their profit and control of the U.S. citizenry. Before May 1, 1933 the Federal Reserve Note was an asset-backed I.O.U. where the bearer could exchange this I.O.U. upon demand at a Federal Reserve Bank for gold (“Legal Tender”), thereafter, for the last 90-years it has been an debt-based I.O.U. that individuals have been passing to each other that must ultimately become worthless. The additional PROBLEM with the debt-based MONOPOLY MONEY known as the FRN currency is how can anyone purchase and claim ownership of anything, including real estate and automobiles, using an I.O.U. NOTE (debt instrument, aka, FRN currency) to acquire ownership, free and clear of all encumbrances?

Since the Federal Reserve started distributing debt-based, fiat-currency Federal Reserve Notes (FRN) in 1934, the FRN currency has fallen ninety-nine percent (99%) in real terms (as measured against gold) by the end of 2022, thereby proving conclusively that the FRN is not money, because it lacks the third element; that being “a store of value”. No fiat currency in the history of the world has ever lasted as money, or currency, as they all have become, or will become, worthless while silver and coin has always retained a store of value. The enemy of the international banksters is gold and silver, because unlike I.O.U. digital currency (FRN), gold and silver cannot be created out of thin air. At the inception of the debt-based FRN, in 1934, gold was valued at $20.67/oz. and today gold is valued at more than $2,000/oz., therefore the value of the FRN currency has fallen by 99-percent. The remaining last one-percent (1%) of the value of the FRN is about to reach its “intrinsic value—zero”, as Voltaire wisely forewarned us in 1729, nearing 300 years ago.

Since 1986, The United States Mint has minted, by U.S. Government mandate, 1 oz. silver coins, having a stamped face value of $1.00, called America Eagle Silver Dollar or simply, Silver Eagles. Each Silver Eagle coin is one troy ounce or 99.9% pure silver. Over 400 million Silver Eagles have been struck and purchased by consumers as of mid-2020. In 2019 the U.S. Mint made and sold 14,863,500 Silver Eagle 1 oz. coins, and in 2020 the U.S. Mint made and sold 30,089,500 Silver Eagle coins, over twice as many because of growing consumer demand as the people loss faith in the only currency of the United States and are looking to protect themselves from the continuing devaluation of the FRN currency relative to silver and gold. The public is beginning to understand that their debt-based fiat-currency, FRN, will soon be worthless. Other privately minted 1 oz. silver rounds or tokens (as they are called because they are not issued or minted by the government) have been issued and purchased by the consumer in quantities much greater than the number of the American Eagles, due to the higher commission and issuance cost of the Eagles, for the same silver content as 1 oz. silver rounds or tokens are.

Authorized by Congress under the Bullion Coin Act of 1985, the American Eagle 1 oz. gold coins have been produced by the U.S. Mint and are legal tender at face value of $50. However these 1 oz. gold Eagles are being sold by the U.S. Mint not at face value, or stamped monetary value, but for over $2,000 per coin. This proves conclusively that the U.S. Government minted $50 American Eagle is NOT money because no one would trade a $50 American Eagle coin for its monetary stamped value of $50. The 1 oz. American Silver Eagle coin, stamped with a $1.00 face value, is currently being sold by the U.S. Mint for approximately $30.00 per coin. Thereby proving that the $1 American Silver Eagle coin is NOT money as no one would exchange the American Silver Eagle coin for its monetary stamped value of $1. The fact that the U.S. Mint sells their American Silver Eagle and Gold Eagle coins for many times their stamped Federal Reserve currency value is proof enough that the Federal Reserve dollar is nearly worthless. No one would sell these coins at their U.S. Government monetary stamped value.

Since the issuance of these silver and gold coin under the Bullion Coin Act of 1985 the Bullion Banks, as they are called have, been using computers linked together through the worldwide communications (internet) network connected to the electronic financial futures market have been creating Federal Reserve Dollars, “at essentially no cost” and other Central Bank currencies around the world to manipulate the price of gold and silver (expressed in $) daily in extreme values to prevent the value of silver and gold significantly rising to show that the Federal Reserve Note Currency is nothing more than a Ponzi scheme.

Federal Reserve Governor—Ben Shalom Bernanke: “The U.S. Government has a technology, called a printing press- or today, its electronic equivalent—that allows it to produce as many U.S. dollars as it wishes at essentially no cost.” Bernanke was presented with the Nobel Peace Prize for Economics after making this statement.

As individuals continue to wake up to this fraud that has been perpetrated upon them, that the FRN is a debt-based currency that certainly will become worthless by design they will want to obtain silver and gold coins, tokens, or bars, or bills to preserve their purchasing power that silver and gold have provided for thousands of years. Clearly this Specification has shown a significant or MAJOR PROBLEM with the FRN currency (aka: “MONOPOLY MONEY”) seriously affecting, adversely, every citizen of the United States.

In 2022, U.S. inflation rate was running at approximately eight-percent (8%) while interest rates on saving accounts are running less than two-percent (2%) thereby giving the saver more than a negative six-percent (6%) annual return on their bank savings. On the other hand the price of silver and gold coins continues to appreciate compared to FRN, while the value of the fiat FRN continues to depreciate relative to the value of silver and gold. For example on Jan. 1, 2023 it took $1869 to buy an ounce of gold and on Dec. 31, 2023 (one year later) it took $2,062 to buy an ounce of gold, or 10.3% more dollars. The Federal Reserve system, in fact, controls inflation by the amount of FRNs, or its equivalent electronic digitized form, they inject, or have in the U.S. monetary-system and thereby they control the rate of inflation. However, the corrupt Federal Reserve banking cartel intentionally deceives the people into believing that inflation is caused by business's raising prices of goods and services which is nothing more than a huge deception and outright and an intentional lie. As economist Milton Friedman famously said,” Inflation is always and everywhere a monetary phenomenon. To control inflation, you need to control the money supply.” The Federal Reserve and their banks through their actions control the amount of their currency (aka: money supply) in the system. Inflation is a tax levied upon the American consumer, American corporation and businesses, and U.S. government by the privately-owned Federal Reserve Banking cartel. The U.S. citizen, individual or collectively, have NO say at all in how and when the privately-owned Federal Reserve destroys their saved currency. That is proof alone that the United States of America, and all of its agencies, including the USPTO are owned and control by the corrupt privately-owned Federal Reserve Banking cartel.

John Maynard Keynes “The best way to destroy the capitalist system is to debauch the currency. By continuing process of inflation, governments can confiscate, secretly and unobserved, an important part of the wealth of their citizens.”
George Washington—“They may pass a law to issue paper money, but twenty laws will not make people receive it. Paper money is founded upon fraud and knavery.”
Henry Ford—“It is well enough that the people of the nation do not understand our banking and monetary system for, if they did, I believe there would be a revolution before tomorrow morning.”

The beginning of reintroduction of real money, that being gold or silver, back into the U.S. economy begins with individuals becoming barterers, by being able to take their coins, tokens, bars, and bills, made of gold or silver and circumvent the corrupt Federal Reserve Note (FRN) currency, on a ‘as needed basis’ to barter for groceries and other goods which will allow then to escape some of the ravages of devaluation of the dying FRN currency (aka: dollar). However, BARTER, BARTERING, and BARTER TRANSACTION is and has been without IMPROVEMENT for 5,000-years. Now with the “inventive method” adding a “practical application” and an “inventive concept” through a TECHNOLOGICAL IMPROVEMENT to the TECHNICAL FIELD of BARTER TRANSACTION has been revolutionized where bartering groceries for silver and gold at the grocer retailer is quick, convenient, cost-savings for both the customer and the business, and allows, both, the customer and the business to circumvent the corrupt FRN dollar.

It was some 50 years ago that magnetic stripe cards came into existence to process SALES TRANSACTION in the United States and around the world. These magnetic stripe cards were used as an intermediate STEP in the SALES TRANSACTION. Each country, around the world, has their own currency, where they have authorized a Central Bank to handle their monetary system. Almost all Central Banks are privately owned where their owners remain anonymous. Its been nearly 50 years where grocery retailers and wholesalers have had their own “closed-loop communications network system” where there SALES TRANSACTIONS are processed on their own proprietary system. Because the privately-owned banking cartels has taken control of the monetary systems from many Countries around the world, BARTER TRANSACTIONS have been replaced by SALES TRANSACTIONS and no one, until now, has invented a BARTER TRANSACTIONS system or method to employ TECHNOLOGY to add a “practical application” or add an “inventive concept” to BARTER, BARTERING, and BARTER TRANSACTION as shown in the present invention to solve the identified PROBLEMS with BARTER TRANSACTION and the PROBLEM with circumventing the MONOPOLY MONEY of a Nation or Country. By changing BARTER to include the exchange of money or currency you effective kill or replace BARTER TRANSACTION with a SALES TRANSACTION. With the present invention BARTER is changed or by adding the “inventive method” or addition STEPS of adding BARTERED VALUE that is NOT money or currency by using a BVC or BVT. The applicant believes that a PHOSITA and the PTAB would find the present invention to be directed to a specific implementation of “a technical solution to a technical problem” using the cited computer-implemented method that cannot be solved by just applying human activity, or generic computer components, but rather by applying the “inventive method” through the computer-implemented program involving a number STEPS requiring specific ACTION. The applicant claims the innovation or the invention, here, is in the SOLUTION and NOT in the PROBLEM. The technological SOLUTION to process BARTER TRANSACTIONS in a specific computer-implemented method creates a new form of BARTER, BARTERING, and BARTER TRANSACTION where the judicial exception is integrated into a “practical application” making it patent eligible subject matter under MPEP 2106.04(D).

It is well-understood, routine, and conventional activity in the technical field of SALES TRANSACTIONS to use a technical field of the business' closed-loop electronic communications network system where the technical field includes the same electronic devices that are used in the present invention, however, it is NOT well-understood, routine, or conventional activity in the present technical field to use the “technical field” of electronic devices to process BARTERED VALUE that is NOT a money or currency on a business' closed-loop electronic communications network system. The “inventive method” of the present invention does NOT lie in the electronic devices stated in the “claims at issue, but instead the inventive method lies in the computer-implemented method where a special computer program makes the electronic devices function in a particular way to perform the inventive method as it is shown in the claims at issue to add and improve technology to the BARTER TRANSACTION and in way that circumvents the use of the FRN currency to make a practical application with an inventive concept to solve the cited technical PROBLEMS. The BARTERED VALUE of a BARTER TRANSACTION has to be kept separate or apart from the digital dollars (aka: FRN currency) of a SALES TRANSACTION being processed on the business' closed-loop electronic communications network system, and they cannot be commingled or combined. (see following citations):

See also McRO, Inc. v. Bandai Namco Games Am. Inc., 837 F.3d 1299, 1315, 120 USPQ2d 1091, 1102 (Fed. Cir. 2016), (holding that a process producing an intangible result (a sequence of synchronized, animated characters) was eligible because it improved an existing technological process).”
“improves the existing technological process”. Microsoft Corp., 662 Fed. App'x at 986, the features were not conventional and thus were considered to reflect an improvement to existing technology.

The present invention improved the existing technological process because the business does NOT have to borrow FRN currency into existence and pay interest to obtain the customer's silver and gold for payment of the groceries and other goods. This is a clear improvement to the business. This inventive method clearly improves the business' profit margin. Furthermore, there are many, many other benefits shown in the OBJECTS OF THE INVENTION listed below.

Remember that a FRN currency on a gift card or a prepaid card is a debt-based currency that has to be borrowed into existence with interest before it can be assigned to the gift card or paid card. The “intangible” VALUE (aka: $) assigned to a Gift Card is NOT the same “intangible” VALUE assigned to a BVC. The BARTERED VALUE assigned to a BVC, or BVT, BVMD is NOT a debt-based currency, nor is it an asset-backed currency, nor is it a currency at all, and the BARTERED VALUE does NOT need to be borrowed into existence. This must be understood by the examiner, PHOSITA, or PTAB.

The number one draw back to owning gold and silver coins or tokens is that the consumer repeatedly says: “I cannot take gold or silver coins to the grocery store to buy food”. Now, with the “inventive method: silver and gold coins, and the alike, can be taken to the grocery retailer and BARTERED for groceries and other goods, where the retailer does NOT have to borrow FRN currency to pay for the silver and gold, thus significantly improving the business' cashflow. The “inventive method” provides SIGNIFICANTLY MORE to both the business and customer (see OBJECTS OF THE INVENTION below). The specifications herein have identified a significant or major PROBLEM with the current and only authorized currency of the United States of America, that being with the Federal Reserve Note (FRN) currency, and the inherent PROBLEM of barter is lacking a “practical application”. Now the present invention after identifying these significant PROBLEMS herein the Specifications, has identified in the a solution to the PROBLEMS with the debt-based Federal Reserve Note (FRN) currency and the 5,000-year old PROBLEM with the Barter System in the CLAIMS of the present application. The “inventive method” of present invention with its “invention concept” (aka: “significantly more” as defined in MPEP 2106.05) and with its “practical application” (as defined under MPEP 2106.04(D)) solves this “problem” that has herein been identified and wherein the SOLUTION is stated “distinctly” and definitely” in the CLAIMS as a whole; a “solution” which may help prevent millions of people from starving to death when that last one-percent of value of the FRN currency finally goes from being worth less to being worthless, soon. The retailers and wholesalers, such as Sam's®, Costco®, Walmart®, Target®, Kroger®, Publix®, HyVee® and many others that sells groceries and other goods will not be able to stay in business as the FRN currency finally goes from being worth less to being worthless. The present invention with its “inventive method” and “practical application” and “inventive concept” are “patent subject matter eligible” under 35 U.S.C. 101 for patenting, because the claimed invention, provides a technical SOLUTION to a technical PROBLEM providing a “practical application” and an “inventive concept”, and may be the most important patent application before the USPTO. “A computer that is operated by a program that was created to solve a particular problem in a way that did not exist before becomes a special purpose computer or machine that did not previously exist.” Any claim by the examiner that the “claimed invention” is directed to an abstract idea under Alice v. Mayo Test should quickly realize his claimed judicial exception is integrated into a “practical application” and has an “inventive concept”.

There must be a step toward the return to a silver and gold monetary-system, and away from the current enslavement of the world's debt-based, fiat-currency system owned and controlled by private central banks for their pleasure and profit. Those who own the Federal Reserve banking cartel will NOT give up their MONOPOLY on money. Therefore the applicant has invented a new form of BARTER (aka: “HYBRID-BARTER”) that will circumvent the existing MONOPOLY money.

All retailers and wholesalers selling groceries, throughout the United States, currently accept in exchange for their groceries or other goods only: (1) Federal Reserve Notes in the denominations of $1, $2, $5, $10, $20, $50, and $100, or (2) U.S. Treasury coinage in the denominations of 1, 5, 10, 25, and 50, cents in ‘base-metal’ coins, or (3) credit-card payment which all credit card companies accept only Federal Reserve Notes (FRN) as payment, in physical or digital form, or (4) debit-cards, gift-cards, prepaid cards, stored-value cards, or contactless cards, tokens processed on a open-loop or closed-loop system, where all cards were or are purchased with FRNs in physical or digital form. There is NO prior art, or patent, or patent application that shows, or describes, or claims, or explains where magnetic-strip cards, mag-stripe cards, smart chip cards, contactless cards or tokens, or its equivalent, (aka: “BVC or BVT) are used in a BARTER TRANSACTION, where the BVC or BVT is assigned BARTERED VALUE, in the United States, or anywhere else, where the BARTERED VALUE is processed on a business's closed-loop electronic communication network system where the BARTERED VALUE or BARTER TRANSACTION is kept separate, or apart from the Federal Reserve, or payment service provider, or bank, or financial institution.

Ben Shalom Bernanke was chairman of the Federal Reserve System when he appeared before a session of Congress where Congressman Ron Paul, on Jul. 18, 2013, asked Chairman Bernanke: “Is gold money?”, where Bernanke replied—“No “. “It's a precious metal”. However, this is what former Chairman of the Federal Reserve, Alan Greenspan, said about gold (who was Bernanke's predecessor): Alan Greenspan: “In the absence of the gold standard, there is no way to protect savings from confiscation through inflation. There is no safe store of value. Deficit spending is simply a scheme for the confiscation of wealth. Gold stands in the way of this insidious process. It stands as the protector of property rights. If one grasps this, one has no difficulty in understanding the statist's antagonism toward the gold standard. A free society needs the rule of gold”. This should be proof enough that we who are citizens of the United States do NOT live in a “free society”. All U.S. citizens are DEBT-SLAVES to the debt-based monetary-system controlled by those few who own the privately-owned Federal Reserve corporation. Once physical cash (FRN) becomes worthless and is replaced by their planned debt-based CBDC, all SALES TRANSACTIONS will be monitored and approved or decline by the those who own the Central Banks. Those individuals who do not comply with the dictates of the Central Bank will have their account turned off. The present invention may prevent citizens of the United States, or its successor, from starving to death.

The following was taken from federalreserve..gov website: “Federal Reserve notes are not redeemable in gold, silver, or any other commodity. Federal Reserve notes have not been redeemable in gold since Jan. 30, 1934, when the Congress amended Section 16 of the Federal Reserve Act to read: “The said [Federal Reserve] notes shall be obligations of the United States . . . . They shall be redeemed in lawful money on demand at the Treasury Department of the United States, [31 U.S.C. 5103] in the city of Washington, District of Columbia, or at any Federal Reserve bank. Federal Reserve notes have not been redeemable in silver since the 1960s.” Today the FRN is only redeemable for itself at any Federal Reserve bank as there is NO “lawful money” only I.O.U.s. The U.S. government and the Federal Reserve System does not, currently, consider gold or silver coins “Legal Tender” or money. Each Federal Reserve Note is an I.O.U. that has a lien against it and as a result they are NOT really money, but a debt obligation. In other words the current MONOPOLY MONEY system is a fraudulent PONZI scam operated by the Federal Reserve.

31 U.S.C. 5103 LEGAL TENDER states: United States coins and currency (including Federal reserve notes and circulating notes of Federal reserve banks and national banks) are legal tender for all debts, public charges, taxes, and dues. Foreign gold or silver coins are not legal tender for debts.

Accordingly, gold and silver are not money they are precious metals and during the entire barter transaction as specified in claims of the present invention gold and silver coins, and or tokens, and or bars, and or bills do not represent currency or money, during the BARTER TRANSACTION, but represent a Barter Value or Bartered Value, which is NOT Federal Reserve Note (FRN) currency, or its digital equivalent, or Central Bank Digital Currency (CBDC), or United States of America currency, or its successor, where a tangible item of value is bartered or exchanged for another tangible item of value during the barter or barter transaction and NO currency or money is exchanged during the BARTER TRANSACTION.

In 1976 the United States of America celebrated its 200th anniversary. In that year the Federal Debt of the United States reached 620 Billion Federal Reserve dollars. As the applicant writes this application, Fox News on Jul. 10, 2023 at 1:38 EDT publishes an article that states: “Federal debt explodes by “1 trillion in five weeks since deal suspending limit became law”. To put this in perspective it took 200 years for the U.S. government to go into DEBT of 620 Billion Dollars and in those mentioned five weeks it has added ONE TRILLION DOLLARS in additional DEBT. That means THE END IS NIGH FOR THE DOLLAR because the debt-based FRN has now entered a parabolic move up. In 2008 there was a financial crisis that almost took down the world's financial system that is today interconnected. The Federal Reserve (which should only be concerned about the United States) injected into the world financial system (as the lender of last resort) over four-trillion dollars to BAIL-OUT the banks around the world to keep their PONZI scheme from collapsing because the FRN is considered the World's Reserve Currency (WRC). The four-trillion dollars were created by the Federal Reserve with about thirteen key stokes on a computer in a couple of seconds.

Federal Reserve Governor—Ben Shalom Bernanke: “The U.S. Government has a technology, called a printing press—or today, its electronic equivalent—that allows it to produce as many U.S. dollars as it wishes at essentially no cost.”

Since the obligation of all Federal Reserve Notes (I.O.U.s) are by contract an obligation of the U.S. Government, the U.S. citizens are on the hook for these I.O.U.s or debt obligations, now totaling more than $34,000,000,000,000 without any say whatsoever of how or why this corrupt private company can destroy or devalue the only currency of the United States where the citizens of the U.S. are liable for these debts. This is proof that the United States has fallen to corporate “fascism”. In 2008 the U.S. debt was nine-trillion dollars and of the beginning of 2023 the U.S. Debt over 34—trillion FRN dollars. After the near collapse of the financial system in 2008 Congress in 2010 passed H.R.4173 or the Dodd-Frank Wall Street Reform Act which prevents another “BAIL-OUT” of the banks in the future. The Dodd-Frank law has made it legal for the banking system to do a “BAIL-IN” which calls for the banks to take, or steal, the depositor's money in a bankruptcy of the banks or banking system, once the FDIC fails. Most individuals are unaware that when they deposit FRN currency into their bank account they are transferring their ownership in their currency or money to the bank, whereupon they become an unsecured creditor, but still have lien, which in all likelihood, will turn out to be worthless in the coming bankruptcy of the debt-based financial system. And almost no one understands that unsecured bank depositors stand in line, in a bankruptcy of the entire banking system, behind all of the financial derivatives, which currently amounts to over 600 TRILLION FRN dollars. Therefore, bank depositors stand to lose everything they have in the banks in the very near future. As this information leaks out, individuals will want to become barterers, and will want to take money out of the banks and convert it, or barter it anyway they can, before the banks fail or where the FRN currency finally goes from being worth less to being worthless. The individuals will realize it is better to trust a grocery retailer or wholesaler than a bank by converting their FRNs into Bartered Value on a BVD using the “claimed invention” to dump the FRN currency.

The average U.S. citizen does not understand how the corrupt Federal Reserve banking cartel is stealing their wealth and savings through inflation (see Alan Greenspans quote above). Just like the Federal Reserve caused the Great Depression they are now causing the “Great, Great Depression”, that is at our doorstep.

Thomas Jefferson—“The modern theory of the perpetuation of debt has drenched the earth with blood, and crushed its inhabitants under burdens ever accumulating.”
Thomas Jefferson (The debate over the re-charter of the Bank Bill 1809)—“I believe that banking institutions are more dangerous to our liberties than standing armies . . . . If the American people ever allow private banks to control the issue of their currency, first by inflation, then by deflation, the banks and corporations that will grow up around [the banks] . . . will deprive the people of all property until their children wake-up homeless on the continent their fathers conquered . . . The issuing power should be taken from the banks and restored to the people, to whom it properly belongs.”

Billions of people worldwide will starve to death, soon when the banksters' worldwide debt-based, fiat-monetary PONZI scheme finally collapses by design. In the last Great Depression the Federal Reserve planned their Deflationary Depression that resulted in their FRN currency removing the gold convertibility where the FRN currency was turned into a debt-based currency backed by nothing. This time the FRN currency is well on its way to hyper-inflation. Assuming that, the Federal Reserve is planning on a MAJOR event occurring, most likely a CYPER-ATTACK upon the world's financial system to extinguish current $307 trillion in world debt. This event will be the GREAT DEBT JUBILEE. But, this planned event will result in the “Great Taking” of all assets of everyone, where everyone will be forced to identify and declare all claimed assets that will be forfeited for CBDC. In 2106 a video by the World Economic Forum (WEF) coined the phrase: “By 2030 you'll own nothing and you'll be happy”. The WEF is a nefarious organization where its Wizards pull the levers behind the curtain that rules the world, where its members include many BANKSTERS. They have by this statement forewarned us of their plan. During the coming Great, Great Depression or the Great World Depression, the Central Bank (probably through the IMF) will issue their CBDC to enslave the people remaining alive as their next phase to their utopian New World Order (NWO). Where every transaction using CBDC can be tracked and traced, by the privately-owned Central Bank, and where any individual's account can be denied a purchase (for anything unacceptable to the Ruler's, or turned-off if the individual's coming Social Credit Score (SCS) is too low, or their behavior is deemed to be unacceptable by those who own and control the privately-owned Central Banking Cartel (CBC). That the applicant contends is a significant PROBLEM. At that point George Orwell's world that he had envisioned has arrived. George Orwell—“If you want a picture of the future, imagine a boot stamping on a human face, forever.” It is imperative that a “free society” has a monetary-system backed by silver and or gold and not backed by a privately-owned banking cartel's electronic MONOPOLY MONEY. The business method of the present invention will help the United States of America return to being a “free society”. It is extremely important, and pertinent to the present invention, for the examiner to read what others had to state regarding this matter to understand the significance and importance of the BACKGROUND OF THE PRESENT INVENTION.

George Washington—“They may pass a law to issue paper money, but twenty laws will not make people receive it. Paper money is founded upon fraud and knavery.”
Mayer Amschel Rothschild—1828: “Allow me to issue and control the money of a nation, and I care not who writes the laws.”
Benjamin Franklin—“When the people find they can vote themselves money, that will herald the end of the republic.”
John Maynard Keynes—1919: “Irredeemable currency is a symptom of a great national sickness. It ‘engages all the hidden forces of economic law on the side of destruction which not one man in a million is able to diagnose.”
Henry Kissinger (creator of the corrupt PetroDollar)—“Who controls the food supply controls the people; who controls energy can control whole continents; who control money controls the world.”
Ludwig von Mises, Human Action—1949: “There is no means of avoiding thefinal collapse of a boom brought about by credit expansion. The alternative is only whether the crisis should come sooner as the result of voluntary abandonment of further credit expansion, or later as a final and total catastrophe of the currency system involved.”

The examiner, in his examination of the present application must understand that barter and barter transactions are NOT like the 99+percent of the Transactions that take place daily. SALES Transactions or BUYING Transactions in the United States involve the ONLY approved currency or money called the FEDERAL RESERVE NOTE (FRN) currency (aka: MONOPOLY MONEY). This currency (FRN) is commonly called cash or money, or currency, or debt-based currency and is denoted in print, on display on an US International computer keyboard as $ (the dollar sign). So within the borders of the United States of America the Federal Reserve Note (FRN) currency is the ONLY authorized and approved currency or money to pay taxes and to BUY and SELL goods and services. Anyone who attempts to buy goods and services with COUNTERFEIT Federal Reserve currency, in physical form or digital form, is immediately arrested and punished, not by the Federal Reserve, but by their “Secret Service”, an U.S. government agency. The “inventive method” of the “claimed invention” cannot simply have said business create COUNTERFEIT digital FRN currency and pass it off as BARTERED VALUE or money or currency. That would be illegal under the counterfeiting laws. Every created FRN currency, assigned to a GIFT CARD or otherwise, has to be borrowed into existence with interest, payable to the Federal Reserve Banking cartel under strict guidance. The “inventive method” is a “NEW WAY OF DOING BUSINESS”. By the applicant inventing a “NEW WAY [aka: method] OF DOING BUSINESS” he is entitled to a patent under the U.S. Patent laws of the United States. Electronic BARTER TRANSACTION of the present inventive method is a completely DIFFERENT WAY OF DOING BUSINESS because it has never before been done. As there is an exchange of groceries and other goods between a business and a customer who barters silver and gold for groceries and other goods where the exchange is NOT done using FEDERAL RESERVE NOTE (FRN) currency (i.e. $, cash, money) in a SALES TRANSACTION, and where there is a intermediate STEP in the BARTER TRANSACTION where BARTERED VALUE is assigned to a BVC or BVT and processed on the business' closed-loop electronic communications network system, using a special computer-implemented program, which processes the BARTER TRANSACTION separate from SALES TRANSACTIONS of the business and is not processed by, or associated with: a payment service provider, or bank, or financial institution, or the Federal Reserve. The BARTERED VALUE is kept internal to said business operation and is NOT processed outside of said business through the computer-implemented method. Therefore, these two types of TRANSACTIONS, (1) “SALES TRANSACTIONS” and (2) “BARTER TRANSACTIONS”, using new technology to the BARTER TRANSACTION are different. One is known as a SALES or BUYING TRANSACTION for FRN physical currency, or its digital equivalent, or a Country's currency, and the other is known as a BARTER TRANSACTION involving BARTERED VALUE that is NOT currency or money of any Country. The INTERNAL REVENUE SERVICE (IRS) knows and understands the difference and so should the USPTO examiner or the PTAB. The IRS requires BARTER TRANSACTIONS to be reported differently from normal SALES TRANSACTIONS. The examiner is probably unaware that a further difference exist between a normal BUYING and SELLING TRANSACTION and a BARTER TRANSACTION and that is according to the IRS a BARTER TRANSACTION creates a TAXABLE and REPORTABLE TRANSACTION to BOTH parties, where a normal SALES and BUYING TRANSACTION does NOT. The retailer or wholesaler has to report to the IRS all BARTER TRANSACTIONS, therefore the applicant has created in the present application and its claims the BARTER TRANSACTION FORM (BTF) which provides a crucial TAX RECORD for the individual as well as the retailer or wholesaler the BARTER TRANSACTION which can be used to report the BARTER TRANSACTION to the IRS, when the BARTER TRANSACTION is properly coded, or computer programed as a BARTER TRANSACTION.

Robert H. Hamphill, Atlanta Federal Reserve Bank Credit manager “This is a staggering thought. We are completely dependent on the commercial banks. Someone has to borrow every dollar we have in circulation, cash or credit. If the banks create ample synthetic money, we are prosperous; if not, we starve. We are absolutely without a permanent money system. When one gets a complete grasp of the picture, the tragic absurdity of our hopeless civilization may collapse unless it becomes widely understood and the defects remedied very soon.”
Congressman Louis McFadden, Chairman of House Comm. on Banking and Currency from 1920 to 1931—“When the Federal Reserve Act was passed, the people of these United States did not perceive that a world banking system was being set up here. A super-state controlled by international bankers and international industrialists acting together to enslave the world for their own pleasure. Every effort has been made by the Fed [Reserve] to conceal its powers but the truth is—THE FED HAS USURPED THE GOVERNMENT!”

Again, the business is NOT BUYING the silver and gold from the customer, so the business does NOT have to BORROW the FRN currency into existence with interest to acquire the customer's silver and gold. Instead the business is BARTERING groceries and other goods for the customer's silver and gold, but is doing so by adding a TECHNOLOGICAL STEP in the computer-implemented process by issuing a BVC and assigning BARTERED VALUE in the BARTER TRANSACTION that is NOT currency or money. This is a huge advancement in the “technical field” of transferring ownership of groceries and other goods. BUT, this computer-implemented method in order for the process to work the business cannot simply use the existing open-loop or closed-loop electronic communications network system that uses a payment service provide, or bank, or financial institution to process digital FRN currency to transfer ownership of the goods from the business to the customer. The business' existing closed-loop electronic commutation network system has to be modified, or made anew, in order for the “inventive method” to work by making sure the computer-implemented program processes the BARTERED VALUE ONLY internal to said business as NO payment service provide, bank, or financial institution would accept the BARTERED VALUE because it is NOT FRN currency.

The corrupt Federal Reserve is well aware that their failing FRN currency will soon be worthless. That is why, the applicant believes, they are planning on the largest financial collapse to occur the world has ever experienced, so they can lay claim and seize ALL of the citizen's assets under their GLOBAL RESET and force upon the citizens of our world to accept the coming NEW WORLD ORDER, to create a One World Government and their Central Bank Digital Currency (CBDC), both of which they will control to enslave everyone. More than likely the cause of the coming collapse will be a planned cyber-attack, or a phony EMP-attack, or CME-attack, where they will probably trip their MASTER SWITCH to starve billions to obtain their “RESET” and steal assets from the citizens of the United States as they did in the last Great Depression.

President John Adams (2nd President of the United States who was assassinated the same day and year the 3rd President of the United States was, which coincidentally was on the 50th anniversary of them signing the Declaration of Independence)—“When people talk of the freedom of writing, speaking, or thinking, I cannot choose but laugh. No such thing ever existed. No such thing now exists; but I hope it will exist. But it must be hundreds of years after you and I shall write and speak no more.”
Frank Zappa—“The illusion of freedom will continue as long as it's profitable to continue the illusion. At the point where the illusion becomes too expensive to maintain, they will just take down the scenery, they will pull back the curtains, they will move the tables and chairs out of the way and you will see the brick wall at the back of the theater.”
Communist Joseph Stalin—“Those who vote decide nothing. Those who count the vote decide everything.”
Lord Acton, Lord Chief Justice of England, 1875—“The issue which has swept down the centuries and which will have to be fought sooner or later is The People vs. The Banks.”

Again, all of the above is part of the BACKGROUND OF THE INVENTION which is absolutely necessary in this application to give the examiners this knowledge they did NOT previously possess. They cannot begin to understand the present application without the ‘knowledge’ that the pro se applicant is divulging in this application. The “knowledge” the examiner thinks he possesses on this subject is an “illusion”.

Stephen Hawking—“The greatest enemy of knowledge is not ignorance—it is the illusion of knowledge.”

The applicant contends that the knowledge that examiners have regarding money and currency of the United States is an “illusion” which must be overcome before they examine the present application.

### SUMMARY OF THE INVENTION

35 U.S.C. 101 states: “Whoever invents or discovers any new and useful process, machine, manufacture, or composition of matter, or any new and useful improvement thereof, may obtain a patent therefor, subject to the conditions and requirements of this title.” 35 U.S.C. 103 states: “A patent for a claimed invention may not be obtained, notwithstanding that the claimed invention is not identically disclosed as set forth in section 102, if the differences between the claimed invention and the prior art are such that the claimed invention as a whole would have been obvious before the effective filing date of the claimed invention to a person having ordinary skill in the art to which the claimed invention pertains. Patentability shall not be negated by the manner in which the invention was made.”

The applicant claims he has invented or discovered a new and useful process, or a new and useful improvement thereof and may obtain a patent thereof. The applicant further claims that the “claimed invention” is NOT “identically disclosed” in ANY prior art, and therefore is NEW. Without any question, whatsoever, the applicant has “improved” the method of BARTER, BARTERING, and BARTER TRANSACTION with the present invention and therefore, “Patentability shall not be negated by the manner in which the invention was made.” The applicant claims that the claims at issue provide a “practical application” under MPEP 2106.04(d)(1), 2106.05(a), 2106.05(e) and a “inventive concept” (aka: “significantly more”) under MPEP 2106.04(d)(1), 2106.05(a), 2106.05(e).

If a patent had been issued 5,000 years ago for BARTER, then the applicant claims he would be entitled to an “IMPROVEMENT PATENT” for BARTER (aka: “HYBRID-BARTER”), but obviously a patent has NOT been issued then. However, 35 U.S.C. 101 specifically states: “Whoever invents or discovers any new and useful process, machine, manufacture, or composition of matter, or any new and useful improvement thereof, may obtain a patent therefor”. The applicant claims he has invented or discovered a new and useful process (aka: “method”) OR a new and useful improvement thereof, which cannot be denied by the examiner.

The applicant has stated in these specifications that the Federal Reserve banking cartel has not only taken control of the United States monetary system, but has taken control of the United States Government and all of it controlled entities including the USPTO.

President Franklin D. Roosevelt to Colonel Edward House (Rothschild's agent), on Nov. 21, 1933—“The real truth of the matter is, as you and I know, that a financial element in the large centers has owned the government ever since the days of Andrew Jackson.”

Nathan Rothschild, 1828—“Permit me to issue and control the money of a nation, and I care not who makes its law”.

As such the applicant believes that the USPTO may not be able to act contrary to the interests of the corrupt Federal Reserve banking cartel. Clearly the present invention circumvents the dictatorial control of the MONOPOLY MONEY of the Federal Reserve Note currency for the acquisition of goods and services. The applicant questions whether the USPTO/examiner can examine the present application without a biased favor toward the Federal Reserve and without a biased disfavor toward the present application. This statement is also directed to the PTAB.

The applicant claims that by inventing a new and useful process or discovering a new and useful improvement to a process, as shown herein, he is entitled to a patent, subject to the conditions and requirements of this title, such as the requirement under 35 U.S.C. 101 that requires the “abstract idea” (aka: “fundamental economic practice”) be integrated into a “practical application”. However, the UPSTO on its website states that: “Integration into a practical application is yet to be judicially defined”, In 2019 PEG defines it as “apply[ing], rely[ing] on, or us[ing] the judicial exception in a manner that imposes a meaningful limit on the judicial exception, such that the claim is more than a drafting effort designed to monopolize the judicial exception.”

The applicant claims that the “abstract idea” of the present invention integrates the judicial exception into a “practical application” by improving the computer or other technical field with the computer-implemented method using technology to circumvent the corrupt FRN currency and to improve BARTER, BARTERING, and BARTER TRANSACTION while the “claims” “imposes a meaningful limit on the judicial exception, such that the claim is more than a drafting effort designed to monopolize the judicial exception”. (see MPEP 2106.04(d)). The applicant further claims that “the claimed invention modifies the internal operation of a computer system and is therefore technical”.

In addition, the USPTO website states the following in favor of the present invention:
(1) “Even if one or more additional elements are well-understood, routine, conventional activity when considered individually, the combination of additional elements may amount to an inventive concept.Diamond v. Diehr, 450 U.S. at 188, 209 USPQ at 9 (1981)”
(2) “For example, in BASCOM, even though the court found that all of the additional elements in the claim recited generic computer network or Internet components, the elements in combination amounted to significantly more because of the non-conventional and non-generic arrangement that provided a technical improvement in the art. BASCOM Global Internet Servs. v. AT&T Mobility LLC, 827 F.3d 1341, 1350-51, 119 USPQ2d 1236, 1243-44 (2016).”
(3) “If the elements or functions are beyond those recognized in the art or by the courts as being well-understood, routine, conventional activity, then the elements or functions will in most cases amount to significantly more (Step 2B: YES).”
(4) “On the other hand, courts have held computer-implemented processes to be significantly more than an abstract idea (and thus eligible), where generic computer components are able in combination to perform functions that are not merely generic. DDR Holdings, LLC v. Hotels.com, L.P., 773 F.3d 1245, 1257-59, 113 USPQ2d 1097, 1105-07 (Fed. Cir. 2014).”

The applicant understands that the electronically activated devices stated in the claims including a computer, by themselves, are NOT sufficient to provide a “practical application” or and “inventive concept” (aka: “significantly more”), however, the applicant claims that the computer-implemented instructions provided by the computer program(s) of the present invention have the technical effect of enhancing the internal operation of the computer by facilitating the technical character which provides a “practical application” and “significantly more”. The applicant claims that the computer program(s) that directs the electronically activated devices, of the “technical field”, to perform the specific functions of the claimed invention through specific program(s) or algorithm(s) accomplishes the “inventive method” of the claimed invention with “significantly more”. Each retail or wholesaler that uses the “inventive method” will program their electronically activated devices of said “technical field” of the claim invention to their own particular protocol, but such should fall within the scope of the claimed invention, providing they follow the “method” of the “claimed invention”.

The applicant claims that the judicial exception is integrated into a “practical application” as shown in the specifications and the claims impose a meaningful limit on the judicial exception, such that the claim(s) are more than a drafting effort designed to monopolize the judicial exception as required by 35 U.S.C. 101. The Summary of the Invention further clarifies the present computer-implemented method improves or enhances the “Technical Field”, including the “closed-loop electronic communications network” of the present invention by making the BARTER TRANSACTION from beginning to end possible without the use on currency or money by using an intermediate technical STEP in the BARTER TRANSACTION that creates an “practical application” employing a computer-implemented method to significantly change the character of the 5,000 year-old BARTER TRANSACTION. Now millions of individual in the United States can quickly and conveniently BARTER their silver and gold coins, and the alike, for groceries and other goods, at the business using their NEW closed-loop electronic network system to process BARTERED VALUE according the the cited “claimed invention”, without being forced to BUY these items with currency or money.

In summary of the present invention it is clear that the inventive method has never before been used in a BARTER TRANSACTION, and therefore it is NOT well-understood, routine, or conventional and therefore favors eligibility under 35 U.S.C. 101 guidelines, and “Even if one or more additional elements are well-understood, routine, conventional activity when considered individually, the combination of additional elements may amount to an inventive concept. Diamond v. Diehr, 450 U.S. at 188, 209 USPQ at 9 (1981)”. 2106.04(d)(1) Evaluating Improvements in the Functioning of a Computer, or an Improvement to Any Other Technology or Technical Field in Step 2A Prong Two [R-10.2019]

A claim reciting a judicial exception is not directed to the judicial exception if it also recites additional elements demonstrating that the claim as a whole integrates the exception into a practical application. One way to demonstrate such integration is when the claimed invention improves the functioning of a computer or improves another technology or technical field . . . the claimed invention may integrate the judicial exception into a practical application by demonstrating that it improves the relevant existing technology although it may not be an improvement over well-understood, routine, conventional activity. It should be noted that while this consideration is often referred to in an abbreviated manner as the “improvements consideration,” the word “improvements” in the context of this consideration is limited to improvements to the functioning of a computer or any other technology/technical field.

The claims are directed to a method that “improves another technology or technical field”. The specification and the claims assert technical improvement. The specifications identifies the problem with barter and the problem with circumventing the currency of the United States (aka: FNR currency) and the claims of the present invention identifies the technical solution to the technical problem(s) through an “inventive method” employing an a “practical application” and or an “inventive concept” (aka: “significantly more”) through specific technical improvement and enhancement that is NOT cited in any prior art.

The applicant claims that he did not ONLY add technology to the method of BARTER TRANSACTION, but he improved the technology of the “technical field” after adding technology and he did this by adding claim elements to the computer-implemented method by making sure the BARTERED VALUE on or assigned to the BVC or BVT or closed-loop electronic communications network system is NOT exposed to any payment service prover, or bank, or financial institution, or Federal Reserve, furthermore the computer-implemented program must process “BARTER TRANSACTION to be separate or apart from SALES TRANSACTIONS. This is because the inventive method or “inventive concept” ONLY works by adding these claim elements in combination with other claim elements because the Federal Reserve banking cartel will NOT permit BARTERED VALUE to be processed on the Federal Reserve banking electronic communications network system that ONLY allows their MONOPOLY MONEY (aka: FRN currency) to be processed. Also since, obviously, BARTER TRANSACTIONS are different from SALES TRANSACTION the computer-implement program must not commingle the two together, but must process the two “separate or apart”. Just like the IRS requires that BARTER TRANSACTIONS be reported separate from SALES TRANSACTIONS. Currently the business' closed-loop electronic communication network system and the open-loop electronic communications network system have gateways to the Federal Reserve banks, or financial institutions, or payment service providers that ONLY process FRN currency in the United States. Therefore with the “inventive method” the business' must create a new and different computer-implemented program where their computers can to process a BARTER TRANSACTION according to the dictates of the “claimed invention”.

Not ONLY is technology added to the BARTER, BARTERING, and BARTER TRANSACTION through the present invention, but technology once added is further IMPROVED to the “technical field” by adding “additional elements” further amount to an “inventive concept” (aka: “significantly more”) where the computer-implemented method programs the “inventive method” to process the BARTER TRANSACTION internal to the business' closed-loop communications network system where the BARTERED VALUE or BARTER TRANSACTION is NOT exposed to any payment service provider, or bank, of financial institution, or Federal Reserve, and where the BARTER TRANSACTION is kept separate or apart from SALES TRANSACTIONS. The applicant claims that that the computer-implemented method of the present invention is “significantly more” than the abstract idea because the computer components, or electronically activated devices, are able in combination to perform functions that are NOT “merely generic” (see following citation), but rather are very specific to perform the inventive method. The applicant claims that the intangible BARTERED VALUE on a BVC being processed on the business' closed-loop electronic communications network system programmed for BARTER TRANSACTIONS that must keep SALES TRANSACTION separate or apart from BARTER TRANSACTIONS where the BVC, BVT, or BVMD maybe assigned both BARTERED VALUE and FRN currency to pay for SALES TAX on the same BVC, or BVT, or BVMD device. Again, the business in acquiring silver and gold from their customers do NOT have to borrow FRN into existence with interest, they can simply create BARTERED VALUE which is ONLY an obligation to BARTER or exchange groceries and other goods with the customer, which clearly is an inventive method employing a “practical application” having “significantly more” where the performed computer functions are NOT “generic”, nor “insignificant extra solution activity”.

“On the other hand, courts have held computer-implemented processes to be significantly more than an abstract idea (and thus eligible), where generic computer components are able in combination to perform functions that are not merely generic. DDR Holdings, LLC v. Hotels.com, L.P., 773 F.3d 1245, 1257-59, 113 USPQ2d 1097, 1105-07 (Fed. Cir. 2014).”
ii. Inprovements to any other technology or technical field, e.g., a modification of conventional rubber-imolding processes to utilize a thermocouple inside the mold to constantly mnonitor the temperature and thus reduce under- and over-curing problems common in the art, as discussed in Diamond v. Diehr, 450 U.S. 175, 191-92, 209 USPQ 1, 10 (1981) (seeMPEP 2106.05(a). If the element is not widely prevalent or in common use, or is otherwise beyond those elements recognized in the art or by the courts as being well-understood, routine or conventional, then the element will in most cases favor eligibility.

The method for a business bartering groceries and other goods for coins, and or tokens, and or bars, and or bills, made of gold or silver, begins where said business provides a quick and convenient method allowing said individual to barter their coins, tokens, bars, and bills, made of gold or silver, acceptable to said business using a provided computer-implemented BARTER TRANSACTION FORM (BTF), or the alike, on their website, or webpage, or web-app, or the alike, where within minutes the individual can complete said BTF on-line using the internet and a computer device and obtain a Barter Offer, or Barter Value, or Bartered Offer, or Bartered Value for his or her coins, or tokens, or bars, or bills and where the offer or BARTER VALUE may or may not be locked-in for a specific amount of time by said business, such as delivering the barter or bartered items to the authorized customer service counter before the close of business the following day. By the business completing a BTF, or the alike, on-line ahead of the individual appearing at said business in-person said business can process a barter transaction quickly and efficiently. The individual using a smartphone or electronic computer or other electronic device that is connected to the internet to get on a website or webpage or web-app of said business, or it authorized affiliate, or authorize agent, and clicks on a webpage or web-app, or the alike, that displays the procedure or method of bartering coins, and or tokens, and or bars, and or bills, made of gold or silver, or those approved by the retailer or wholesaler, or its authorized affiliate, for groceries and other goods by said retailer or wholesaler acting or interacting directly with the individual through their own website or web-app, or through their authorized affiliate's website or web-app, or the alike, whereby the individual completes, on-line, certain information, interactively or non-interactively, on said website, or webpage, or web-app, having a BARTER TRANSACTION FORM (BTF), or its equivalent, which can take many different variations of form or format, (see FIG. 4 for one example) or request for information, Barter Offer, or barter depending upon the protocol established by the retailer, or wholesaler, or its authorized affiliate, and which should be understood to be within the scope of the present invention. The BTF, or the alike, can require information from the individual, such as at a minimum, the name of the individual (aka: “customer”), the individual's email address, and quantity and description, or identification, or selection of the coin(s), and or token(s), and or bar(s), and or bill(s), made of gold or silver, that the individual offers for barter, or those that the retailer or wholesaler, or its authorized affiliate, will accept in barter. Where said BTF, or its equivalent, is easily and quickly initiated and or completed by said individual, on-line, where the individual using the website, or webpage, or web-app, or the alike, of the retailer or wholesaler, or its authorized affiliate or agent, can fill in, or type-in, and or click on, the item(s) of gold or silver coin(s), and or token(s) and or bar(s), and or bill(s) and select the quantity of each item intending to barter to quickly obtain a Barter Offer, or Barter Value, or Bartered Offer, or Barter Value, or the alike. The Barter Offer may be subject to change while the Bartered Offer or Bartered Value, may not be subject to change providing the individual exchanges the bartered items at the store's authorized customer service counter within a certain time period (such as before the close of business of the following day of sending the BTF). The BTF, or the alike, or the website, or web-app should state the terms and conditions of the barter transaction, including that said bartering, or barter transaction consists of the exchange of the individual's coins, or tokens, or bars, or bills, acceptable to said business for BARTERED VALUE that is assigned to a BARTERED VALUE CARD (BVC), or the alike, that is used as an intermediate step in the barter transaction, whereafter said BVC having assigned BARTERED VALUE can be used to exchange BARTERED VALUE for groceries an other goods at self or assisted checkout by said individual, where when the BARTERED VALUE is depleted from the BVC, the BARTER TRANSACTION is completed.

Said business may require said individual to furnish other information on said BTF, or the alike, such as any of the following: (a) signature of the individual, or electronic equivalent of the signature of the individual, (b) home address of the individual, (c) cellphone number or telephone number of the individual, (d) driver's license number of the individual, (e) last four digits of the social security number of the individual, (f) the date of the filing the BTF and BTF number, (g) the current Value or Barter Value or Barter Offer of the coin(s), and or token(s), and or bar(s), and or bill(s), made of silver or gold as it appeared on the approved website or web-app, or the alike, of the retailer or wholesaler or its approved vendor's or authorized affiliate's website or web-app, or email, (h) individual checking or identifying that the individual is the owner of the coin(s), and or token(s), and or bar(s), and or bill(s) offered for barter, (i) individual checking or identifying that the individual agrees to accept in barter a Bartered Value Card (BVC), or its equivalent, having assigned Bartered Value equal to the Bartered Offer’ which can be used to exchange for food or other groceries and other goods, in-person or on-line, in the present or in the future, j) checking or identifying that the individual accepts that said BVC and or Bartered Value is nonrefundable for cash, or currency, or Federal Reserve Notes (FRNs) currency, or Central Bank Digital Currency (CBDC), (k) checking that the individual agrees that the BARTERED VALUE is NOT currency or money. It should be understood that many variations of forms or formats of BTFs, or the alike, other than that shown in FIG. 4, requesting information are possible and should all be considered within the scope of the present invention.

Once the individual completes, partially or completely, the BTF, or the alike, the individual sends, electronically, the BTF, or the alike, by an electronic communications network system, or internet, to said retailer or wholesaler or its authorized affiliate, that may be unknown to said individual. The retailer or wholesaler (aka: “business”), or its authorized affiliate, receives said BFT, or the alike, from said individual and reviews said BTF and the information provided by the individual. Once a BTF has been processed, by the computer-implemented program, a BTF number is assigned to said barter transaction. If there exists an authorized affiliate involved in the barter transaction once the BTF has been sent via an electronic communications network by the individual BTF will be reviewed and electronically forwarded to the business' authorized customer service counter computer device through ethernet or internet or email to further said barter transaction. The BTF using the computer-implemented program assigns and calculates the Barter Offer, or Barter Value, or the Bartered Offer, or the Bartered Value, or individual Values or sub-totals, or totals of BARTER or BARTERED VALUE that may or may not vary by the minute or subject to change, depending upon the protocol set by said business or its authorized affiliate, and where such offer or value may or may not be subject to change at the authorized customer service counter based upon the information gathered from the computer-implemented program. The retailer or wholesaler, and or its authorized affiliate, checks the number and type of coin(s), token(s), bar(s), and or bill(s) claimed on the BTF to see if they are compliant to established business protocol as set be the computer-implemented program and the current Barter Value, or Barter Offer, or BARTERED VALUE as set by the computer-implemented program. The on-line Barter Offer or Barter Value or Bartered Offer, or Bartered Value determined from the BTF, or retailer or wholesaler, or its authorized affiliate maybe subject to change before the Bartered Value, or its equivalent, is accepted or agreed upon by said individual and retailer or wholesaler at the authorized service counter of the retailer or wholesaler, according to the terms and conditions of the barter transaction or determined by the retailer or wholesaler or it authorized affiliate. The website, or webpage, or web-app of the retailer or wholesaler or their authorized affiliate may have on their webpage or web-app pertaining to barter of coins, or tokens, or bars, or bills, made of gold or silver, where the individual can or must select the store location and or store number where they want, or directed, to take their coins, or the alike, for barter, or where the retailer or wholesaler will accept the items of barter. The Barter Offer, or Barter Value, or Bartered Offer, or Bartered Value, or the alike, may vary, from store to store within the retail's chain or wholesaler's chain of stores, depending upon or according to the inventory the store has of coins, tokens, bars, and bills. For instance, if the inventory of coins, or the like, that said store has is higher than normal for sale or resale, said Barter Offer, or Barter Value, or Bartered Offer, or Bartered Value offered by may lower than normal, or vice versa. The computer-implemented program can also determine the BARTERED VALUE based also on the level of the store's inventory of silver and gold and the type thereof where the the program can suggest to the customer which store offers the highest BARTERED VALUE within a given radius from the customer's preferred store.

The individual (aka: “customer”) goes, thereafter, to said retailer or wholesaler, by appointment or randomly, and goes before the authorized customer service counter, authorized by the retailer or wholesaler or its authorized affiliate as the place within the store of said business where bartering of gold or silver is done. The individual identifies themself by either presenting an electronic or paper copy of the on-line BTF, or the alike, or the BTF reference number, and or the individual's name or email address, and or cellphone or smartphone number, or by some other means where the computer-implemented program information concerning the BTF is available on the computer device at the authorized customer service counter. The BARTER TRANSACTION between the customer (aka: “individual”) and the business (aka: retailer or wholesaler) then continues at the authorized customer service counter. If the individual did not initiate a BTF, or the alike, before going to the retailer or wholesaler the retailer or wholesaler has at the authorized customer service counter a computer connected to the internet where the individual can use (by swiveling around the computer device mounted to a post or other means or another device) an access the partially-completed BTF for the individual to complete and send in the same fashion had sent the BTF on their own electronic communications device from a different physical location, or the business at customer service counter could complete the BTF, or the alike, on behalf of said customer. The computer device at the authorized customer service counter may also function as an electronic signature pad device.

The individual presents the coin(s), and or token(s), and or bar(s), and or bill(s) made of silver or gold to the business at the authorized service counter for inspection, and or evaluation, and or re-evaluation according to protocol established by the retailer or wholesaler or its authorized affiliate. Either the business accepts or rejects, all or some, or none, of the silver and gold, upon inspection and or evaluation, of the coin(s), and or token(s), and or bar(s), and or bill(s) for barter as determined by protocol set by the retailer or wholesaler, or its authorized affiliate. Where this protocol for inspection might include any of the following: visual inspection, weight inspection, ping test, terminal sliding velocity inspection, chemical analysis inspection, size inspection, magnetic test inspection, drop test analysis, acid test analysis, scratch test analysis, conductivity analysis, potentiometric analysis, ultrasound analysis, hardness analysis, density test analysis, specific gravity test.

Whereafter, the business accepting some or all coins and or tokens, and or bars, and or bills for barter the computer-implemented program confirms, or reconfirms, or determines, or redetermines a Barter Offer, or Barter Value or Bartered Offer, or Bartered Value, or its equivalent, using information on the BTF, and upon inspection, and upon evaluation, and using the computer-implemented program and business' closed-loop electronic communications network device that is connected where the individual upon their review of the Barter Offer, or Barter Value, or Bartered Offer, or Bartered Value, or its equivalent, agrees upon a Bartered Value, or the alike, the individual is required by at the authorized customer service counter to sign their signature on an electronic signature pad device, or its equivalent, connected to the closed-loop electronic communications network of said business, or its equivalent, or a paper copy of a receipt, or agreement or contract accepting the barter transaction whereafter the Bartered Value that is approved for barter, which is then assigned to, or on, or associated with, said BVC, or BVT, or BVMD, where the business scans or reads, and records the unique identifying code of the BVC, or BVT, or BVMD and enters the unique code into closed-loop electronic communications network device using the computer-implemented program where the BARTERED VALUE on or associated with the BVC, or BVT, or BVMD is then used at store's electronic checkout device, or on-line, to debit BARTERED VALUE in exchange for groceries and other goods.

The BVC is a magnetic stripe card, or a mag-stripe card, or a passive transponder card, or a contactless card, or a proximity card, or a RFID (aka: Radio Frequency Identification) card, or a EMV (aka: Europay, Mastercard, and Visa) card, or a smart-chip card, or a two-dimensional matrix card, or a UPC (aka: Universal Product Code) card, or a barcode card, or any combination thereof, and the BVT is an electronically activated 3-dimensional device known as a RFID token, or passive transponder token, a contactless token, or proximity token, and the BVMD is a customer's electronic smartphone, or smart tablet, or smart watch, where each, BVC, or BVT, or BVMD, has a unique identifying code,

Similar cards or tokens now in existence are called: ‘gift cards’, ‘prepaid cards’, ‘stored value cards’ (SVC), ‘stored value tokens’ (SVT), and mobile device (MD). However, all of these cards are different. Gift Cards, Prepaid Cards, and the like, are purchased with FRN currency, in digital form, assigned to the Gift Card or Prepaid Card at check out at the checkout register, where the FRN currency is borrowed into existence with interest and assigned to the Gift Card or Prepaid Card using the cards unique identifying code which is then entered into the business' closed-loop electronic communications network system. Whereas, when the BARTERED VALUE is assigned to a BVC, or BVT, of a BVMD without borrowing any digital currency into existence, because it is NOT currency or money, and has NO counter-party risk or indebtedness. Based on current U.S. Government regulations there are certain legal rules governing “gift card”, and the like. The law states; “The maximum amount that can be purchased by a single person across multiple gift cards is $10,000. The maximum amount that can be purchased by a single person for a single brand is $2,000.” The purchase of these ‘gift cards’, and the like, in the United States require the purchase to be made in Federal Reserve Note (FRN) currency. The present invention and the method thereof concerns a barter or barter transaction involving silver and or gold, exchanged for groceries and other goods, and is not purchased by, nor exchanged for, or refunded for FRN currency or dollars or any other debt-based currency and therefore is not subject to these U.S. Government regulations that regulate ‘gift cards’, ‘prepaid cards’, or the like. A BVC is not a ‘gift card’ or a ‘prepaid card’, instead it is a ‘Bartered Value Card’ (BVC) involving barter where the Bartered Value is not money or currency, as defined by the Federal Reserve and or the U.S. Government, nor is it FRN currency or Central Bank Digital Currency (CBDC), nor is the BVC or BVT backed by silver or gold. Since the business method of the present invention is unique and there is no word, until now, to identify or call the Bartered Value assigned to a Barter Value Card (BVC) or the alike. Being that the Bartered Value is not FRNs, nor dollars, nor cents, but rather numeric, or alphanumeric, or binary code. The applicant claims a new name is needed to identify this BARTERED VALUE resulting from HYBRID-BARTERING. Therefore, the applicant/inventor has named the “unit of measure”, ‘BART’, and its plural form, ‘BARTS’, represented by the capital letter ‘#’ on an U.S. International computer keyboard, which is just left of the $ key, therefore, for example 143 #assigned to a BVC is equal to 143 Barts.

Many States within the United states do NOT tax (aka: “SALES TAX”) groceries, but instead tax only “other goods” that are not considered “food”. In a BARTER TRANSACTION the BARTERED VALUE is NOT FRN currency and therefore processing a BARTER TRANSACTION using a BVC, or BVT, or BVMD would not be able to pay for SALES TAX, which must be paid ONLY with FRN currency. The computer-implemented program can be programmed, along with the BVC, BVT, BVMD to handling processing both the BARTERED VALUE for exchanging BARTERED VALUE for groceries and other goods, while ALSO processing digital FRN currency to pay for SALES TAXES (or other taxes) during the BARTER TRANSACTION. This is covered in a “dependent claim”. Never before has a BVC or a BVT been programmed to process BARTERED VALUE and a SALES TRANSACTION on the same magnetic strip card (or its equivalent), or a contactless token (or its equivalent). The computer-implemented program would have to be specifically programmed to process both BARTERED VALUE and FRN currency VALUE assigned to the BVC, or BVT, or BVMD device., where the FRN currency can be processed by the program to cover SALES TAX of the “goods” that are TAXED during the BARTER TRANSACTION.

The computer-implemented program is designed to keep separate BARTER TRANSACTIONS apart from SALES TRANSACTIONS for business purposes and tax purposes as the Internal Revenue Service (aka: IRS) requires reporting of BARTER TRANSACTION to be separate form SALES TRANSACTIONS, because they are NOT the same. The IRS deems a BARTER TRANSACTION to be a “taxable event” for both parties (i.e. “barterers”) while the SALES TRANSACTION is NOT taxable to the BUYER.

To provide security during the BARTER TRANSACTION when receiving the silver and gold the business puts the bartered silver and gold into a bag and seals it with a tag labeled with the BTF number or a barcode, or its equivalent, that contains the vital information on the BARTER TRANSACTION and drops the tagged bag through a slot in the authorized customer service counter, where the then bag drops through a corresponding slot in a closed security safe for safe keeping. The computer-implemented program then detects and records when the security safe is opened and closed and can activate the video and or photo recording. The computer-implemented program records when the tagged bag of silver and gold was processed and when the safe was opened and closed for that specific BARTER TRANSACTION.

The computer-implemented barter method can still function during and after a Electro-Magnetic Pulse (aka: EMP), manmade or natural, because the “claimed inventive” is NOT dependent on processing a monetary payment (i.e credit card or gift card) through the banking system, but is ONLY dependent on the back-up generators of the business working to operated their refrigeration, lights, and BVC, BVT, BVMD scanners or readers to process a BARTER TRANSACTION.

The business and customer can also barter ‘platinum’ coins, tokens, bars, and bills.

The business' computer-implemented program has a downloaded APP for customers where they can download the APP to their smartphone, smart tablet, or smart watch that has a unique identifying code where the customer's smartphone, smart tablet, or smart watch can process (credit and debit) BARTERED VALUE, just like a BVC, or BVT, BVMD can.

Where any inspection and or evaluation of the coin(s), token(s), bar(s), bill(s) performed at the customer service counter may include any of the following: visual inspection, weight inspection, terminal sliding velocity inspection, chemical analysis inspection, size inspection, magnetic test inspection, spectrographic analysis, X-ray analysis, optical emission spectroscopy analysis, spectrometer analysis, drop test analysis, acid test analysis, scratch test analysis, ping test analysis, conductivity analysis, potentiometric analysis, ultrasound analysis, hardness analysis, density test analysis, specific gravity test.

Where the business' closed-loop electronic communications network system may function using ethernet and or internet.

Where the computer-implemented program keeps track of the profit or loss of each BARTER TRANSACTION relative to what the profit or loss would have been had the BARTER TRANSACTION been done as a SALES TRANSACTION in FRN currency, or CBDC, instead of a BARTER TRANSACTION in BARTERED VALUE.

Where the computer-implemented program knows and tracks BARTER TRANSACTIONS separate or apart from SALES TRANSACTIONS.

The individual saves considerably by BARTERING their silver and gold at the local grocery retailer where they can take their silver and gold during their next shopping trip and where they then do NOT have to pay expensive shipping costs to ship their silver and gold to a coin dealer, nor pay for expensive insurance charges which are considerable because those charges are based on weight and dollar amount. The business besides SAVING by NOT having the borrow FRN currency to buy the silver and gold, does NOT have to pay for inbound shipping costs, nor insurance costs. The “practical application” offered in the “inventive method” saves the business considerable thus significantly boosting their profit margin, by and “inventive concept” that provides “significantly more”.

Besides the business significantly benefiting from the “inventive method’ the individual also benefits significantly by NOT having to pay for expensive shipping and insurance costs to send their heavy silver and gold to a coin dealer.

As of the end of 2022 there were 63,328 functioning grocery stores in the United States according to Drive Research, while according to Rentech Digital there were 4381 Coin Dealers in the United States as of Jan. 9, 2024, so it is obvious that the “inventive method” offers “significantly more” choices to the customer should the grocery retailers and wholesalers adopt the use of the present invention.

### OBJECTS OF THE INVENTION

It is an object of the present invention to provide a technological “inventive method” to improve the method of BARTER, BARTERING, and BARTER TRANSACTION for business that barters groceries and other goods for an individual's silver and gold coins, and the alike, that is directed to “patent eligible subject matter” under 35 U.S.C 101 which incorporates a “practical application” and “inventive concept.

It is another object of the present invention to provide a computer-implemented process that is “significantly more” than the abstract idea (and thus patent eligible subject matter), where generic computer components are in combination to perform functions that are not merely generic. (see following citation)

On the other hand, courts have held computer-implemented processes to be significantly more than an abstract idea (and thus eligible), where generic computer components are able in combination to perform functions that are not merely generic. DDR Holdings, LLC v. Hotels.com, L.P., 773 F.3d 1245, 1257-59, 113 USPQ2d 1097, 1105-07 (Fed. Cir. 2014).

It is another object of the present invention to provide a computer-implemented process that the additional elements of the claims “are beyond those recognized in the art or by the courts as being well-understood, routine, conventional activity, then the elements or functions will in most cases amount to significantly more (Step 2B: YES)”.

It is another object of the present invention to provide a computer-implemented process that the additional “elements in combination amounted to significantly more because of the non-conventional and non-generic arrangement that provided a technical improvement in the art. BASCOM Global Internet Servs. v. AT&T Mobility LLC, 827 F.3d 1341, 1350-51, 119 USPQ2d 1236, 1243-44 (2016).

It is another object of the present invention to provide a computer-implemented process that “Even if one or more additional elements are well-understood, routine, conventional activity when considered individually, the combination of additional elements may amount to an inventive concept. Diamond v. Diehr, 450 U.S. at 188, 209 USPQ at 9 (1981)”.

It is another object of the present invention to provide an “inventive method” using TECHNOLOGY to improve BARTER TRANSACTIONS, while limiting the “claims” so that they do not claim a monopoly on the inventive concept.

It is another object of the present invention to provide an “inventive method” using TECHNOLOGY to circumvent the use of currency or money (aka: FRN currency in physical or digital form) in a BARTER TRANSACTION.

It is another object of the present invention to show a computer-implemented “inventive method” having at least one special computer program that processes BARTERED VALUE, that is NOT a currency or money of any Government, such as FRN currency, or CBDC, on a business' closed-loop electronic communications network system that does not expose the BARTERED VALUE or BARTER TRANSACTION to a bank or financial institution.

It is another object of the present invention to provide an “invention method” using TECHNOLOGY to improve BARTER TRANSACTION, while at the same time circumventing the use of currency or money in the same BARTER TRANSACTION.

It is another object of the present invention to process an “inventive method” of a business that barters groceries and other goods for a barterer's silver and gold where a computer-implemented method, with at least one special computer program, that makes said barter possible using TECHNOLOGY.

It is another object of the present invention to process an “inventive method” of a business that barters groceries and other goods for a barterer's silver and gold where a computer-implemented method, with at least special computer program, is processed on said business' closed-loop electronic communications network system where the BARTERED VALUE is NOT exposed to any bank or financial institution.

It is another object of the present invention to process an “inventive method” of a business that barters groceries and other goods for a barterer's silver and gold where a computer-implemented method, with at least special computer program, is processed on said business' closed-loop electronic communications network system that is specially programmed to process said BARTER TRANSACTIONS so that the BARTERED VALUE is kept internal to said business, and separate and apart from any SALES TRANSACTIONS, and or affiliation with any Federal Reserve BANK, or other BANK, or FINANCIAL INSTITUTION.

It is an object of the present invention to show that the applicant has invented or discovered a new and useful process, or a new and useful improvement thereof, pursuant to 35 U.S.C. 101 and 35 U.S.C. 102, and 35 U.S.C. 103 and is entitled to a patent.

It is another object of the invention to show that the cited new and useful process (aka: method) of the claimed invention is directed to a new and useful BUSINESS METHOD that involves Patent Eligible Subject Matter under 35 U.S.C. 101.

It is an object of the present invention to show that it is directed to an “inventive method” having a “practical application” and an “inventive concept” (aka: “significantly more”) both meeting the requirements under MPEP 2106 as being Patent Subject Matter Eligible.

It is another object of the invention to identify, distinctly and definitely, the “practical application” and the “inventive method” so that a PHOSITA would readily understand and comprehend both as being Patent Subject Matter Eligible under MPEP 2106.

It is another object of the present invention to identify significant or major PROBLEMS, being: (1) with the 5,000-year old BARTER, BARTERING, and BARTER TRANSACTION (aka: BARTER SYSTEM or METHOD) and (2) with the 90-year old debt-based, fiat Federal Reserve Note (FRN) currency (in physical or digital form) that has lost 99-percent of its value, relative to gold, and will soon go from being worth less to being worthless which is the most serious PROBLEM facing the citizens of the United States.

It is another object of the present invention to identify the cited PROBLEMS with the BARTER SYSTEM and the debt-based FRN currency as being TECHNOLOGICAL PROBLEMS and identify the TECHNOLOGICAL SOLUTION in the claims at issue. (see following citation MPEP 2106.05(a)”

“An important consideration in determining whether a claim improves technology is the extent to which the claim covers a particular solution to a problem or a particular way to achieve a desired outcome, as opposed to merely claiming the idea of a solution or outcome. McRO, 837 F.3d at 1314-15, 120 USPQ2d at 1102-03; DDR Holdings, 773 F.3d at 1259, 113 USPQ2d at 1107.”

It is another object of the present invention to identify a TECHNOLOGICAL SOLUTION to the cited TECHNOLOGICAL PROBLEMS identified in the Specifications and to provide the SOLUTION in the “claims”, so that a PHOSITA would distinctly and definitely understand both the TECHNOLOGICAL PROBLEMS and the TECHNOLOGICAL SOLUTIONS, pursuant to MPEP 2106.05(a) where it states: “This consideration has also been referred to as the search for a technological solution to a technological problem. See e.g., DDR Holdings, LLC. v. Hotels.com, L.P., 773 F.3d 1245, 1257, 113 USPQ2d 1097, 1105 (Fed. Cir. 2014); Amdocs (Israel), Ltd. v. Openet Telecom, Inc., 841 F.3d 1288, 1300-01, 120 USPQ2d 1527, 1537 (Fed. Cir. 2016). (2106.05(a)).”

It is another object of the present invention to show “that the invention improves upon conventional functioning of a computer, or, upon conventional technology or technological processes, a technical explanation as to how to implement the invention should be present in the specifications” (2106.05(a)).

It is another object of the present invention to show that the “inventive method” for this Business Methods Patent Application is a new way of doing business that involves a specific use of technology and that there is NO prior art that identically discloses the claimed invention, under 35 U.S.C. 103.

It is another object of the present invention to create a business opportunity whereby the business that is retailers and wholesalers who sells groceries and other goods for ONLY Federal Reserve Notes (FRN), or money authorized by the United States, or it successor, to begin to barter their groceries and other goods for gold and or silver in the form of coins, or tokens, or bars, or bills, thereby reducing the customer's and business's vulnerability to FRN currency that has already lost 99-percent of its value, relative to gold, and may soon become worthless, like all other fiat-currency have over the last 1,000 years.

It is also another object of the present invention to create, what would be equal to, a MULTI-BILLION DOLLAR business opportunity for said business that currently sell groceries and other goods for only FRNs, to begin bartering groceries and other goods for gold and silver coins, tokens, bars, and bills, and where the business can turn around and immediately SELL those gold and silver items for SALE (until FRN currency becomes worthless), thereby greatly improving their sales and their chance of survival.

It is another object of the present invention to substantially improve said business' cashflow by bartering their groceries and other goods for an individual's silver or gold coins, and the alike, because the business does NOT have to BUY the silver and gold and pay using FRN currency, and by issuing or using a BVC, or BVT assigned BARTERED VALUE which the individual make take months to redeem said BARTERED VALUE, thus the business substantially improves its cashflow.

It is another object of the present invention to save the business money by the business NOT having to borrow FRN currency into existence with INTEREST, because the business does NOT BUY the customer's silver and gold, but BARTERS the customer's silver and gold with BARTERED VALUE with does NOT involve any INTEREST cost to the business or cash (aka: “FRN currency”) outlay.

It is another object of the present invention to increase the profitability of the retailer or wholesaler due to the fact that over time the value of the FRN currency has depreciated against silver and gold, where the FRN has lost 99-percent of it value already, so when the retailer or wholesaler takes in silver and gold from the individual and assigns BARTERED VALUE to the BVD the individual may take days, weeks, or months, or more to exchange the BARTERED VALUE for groceries or other goods, during which time it is extremely likely that the prices of the goods has risen thereby protecting the business from the depreciating FRN currency, because the BARTERED VALUE was determined at the initiation of the BARTER TRANSACTION.

It is another object of the present invention to protect the business from the depreciating FRN currency by accepting silver and gold in barter for groceries and other goods, because at the initiation of the BARTER TRANSACTION the BARTERED VALUE is determined by a relationship to the value gold or silver to the FRN currency. Once the BARTERED VALUE is determine and assigned to the BVC or BVT the VALUE is locked in, so any appreciation of the bartered silver and gold will potentially benefit the business rather than the customer.

It is another object of the present invention where said business takes the bartered silver and gold and in turn barters the bartered silver and gold with the business' suppliers of food, or groceries and other good where the supplier may prefer payment in silver and gold as opposed to the dying FRN currency.

It is another object of the present invention to create a record of the barter transaction using a BARTER TRANSACTION FORM (BTF), or its equivalent, where in case of loss of the BVC, or BVT, a new BVC or BVT can be issued with the remaining BARTERED VALUE by the business.

It is an object of the present invention where the “inventive method” does not require the customer to have, or use, a bank or financial institution conduct the BARTER TRANSACTION with the business.

It is another object of the present invention to create a BARTER SYSTEM using TECHNOLOGY that is not connecting to the U.S. banks or financial institutions, and where the BARTER TRANSACTIONS are not viewable, or recordable, or traceable by the Federal Reserve banking cartel.

It is another object of the present invention to create program the computer-implemented method so that the BARTERED VALUED CARD (BVC), or BARTERED VALUE TOKEN (BVT), is directly solely for BARTER TRANSACTIONS with said business.

It is another object of the present invention where the business can assign BARTERED VALUE to the customer's electronic mobile device (aka: “smartphone”) where the customer has downloaded the business' mobile APP, whereafter the smartphone can function as a BARTER VALUE MOBILE DEVICE (BVMD) where the business can assign or debit BARTERED VALUE to the smartphone.

It is another object of the present invention where the “inventive method” uses (1) a BARTERED VALUE CARD (BVC) which is a magnetic stripe card, or a mag-stripe card, or a RFID card, EMV chip card, or a contactless card, or proximity card, or a smart chip card, or a two-dimensional matrix code card, or a UPC card, or a barcode card, or any combination thereof, or (2) a BARTERED VALUE TOKEN (BVT) which is a three-dimensional Token or FOB that is a contactless device containing a micro-chip, or (3) a BARTERED VALUE MOBILE DEVICE (BVMD) which is a smartphone device or smart cellphone device, or other communication device that has an embedded microchip with a connected antenna capable of receiving and transmitted coded information through a business APP where the BVC, BVT, and BVMD are programmed by the business' computer-implemented program to process BARTERED VALUE in a particular way using the “inventive method”.

It is another object of the present invention where the BARTERED VALUE CARD (BVC) is made visually distinguishable from any other mag-stripe card, magnetic strip card, proximity card or token, smart chip card, barcode card, contactless card or token, or any combination thereof, by incorporating the visual words BARTERED VALUE CARD on at least one side of said card.

It is another object of the present invention to have a special computer program that makes a record of the BARTER TRANSACTION which consists of: (1) completed BARTER TRANSACTION FORM (BTF), or its equivalent, (2) any video or photos, (3) any electronic signature of the customer, (4) each TRANSACTION involving debiting or crediting of BARTERED VALUE.

It is another object of the present invention to record by camera photos or video of the BARTER TRANSACTION and the barterers, at the authorized customer service counter for record assigned to the BTF.

It is another object of the present invention that the BVC or BVT is programmed to function only on a closed-loop electronic communications network system of said business who issued the BARTERED VALUE.

It is another object of the present invention that the computer-implemented program keeps track of the profit or loss of each BARTER TRANSACTION relative to what the profit or loss would have been had the BARTER TRANSACTION been done as a SALES TRANSACTION instead of a BARTER TRANSACTION.

It is another object of the present invention to have the computer-implemented program process BOTH BARTERED VALUE and FRN currency (in digital form) on the same BVC, or BVT, or BVMD where the FRN currency is programmed ONLY to pay SALE TAX and or other TAX.

It is another object of the present invention for said business to save individual considerable money in the cost of exchanging his or her coins, tokens, bars, and bills. Currently, the individual has drive maybe considerable distance to a coin dealer or to FEDEX, or UPS, or USPS to ship his or her coins, tokens, bars, and bills. Where, on the other hand, the individual could simply take their coins, and the alike, to his nearest grocery store to barter their coins, and the alike. Also said business will save said individual significant money by the individual not having to pay money for freight charges or shipping costs at FEDEX, or UPS, or USPS to a far away coin dealer. Silver and gold are particular heavy metals and freight or shipping costs are usually by weight and distance which can be considerable. Also said business method will save the individual significant money by the individual not having to pay for insurance costs to insure the value of the coins, tokens, bars, and or bills be shipped. The value of gold and silver can be significant and the cost of insurance is based on the value and the cost can be significant. By said business offering to accept in barter for groceries and other goods for the individual's gold and or silver it saves the individual the insurance costs and the shipping costs. There are literally thousand and thousands more retailers and wholesalers that sell groceries and other goods, that could barter for gold and silver, compared to the small number of coin dealers in the United States.

It is another object of the present invention where the retail or wholesaler can barter the silver and gold coins, and the alike, that they had received in a BARTER TRANSACTION, with their workers, who wish to receive silver and gold coins, and the alike, in payment for their labor instead of being paid FRN currency for their labor.

It is another object of the present invention where said business can replace, to a certain degree, the function of a bank during a coming potential depression and bank closures, where the individual has lost access to obtaining FRNs through the banking system, but has access to his gold and silver coins, and the alike, for barter with said business. In the event of the FRN hyper-inflating to become worthless said business conducting the method of the present invention could replace the FRN currency (aka: SALES TRANSACTION) and still transact business through barter (aka: BARTER TRANSACTION).

It is another object of the present invention where said business could take the bartered silver and gold received from their customers and in turn barter the silver and gold with their suppliers of food, groceries and other goods instead of paying for these items with FRN currency.

It is another object of the present invention is to make the process of purchasing, selling, and bartering coins, tokens, bars, and bills, made of gold or silver much more convenient, efficient, and cheaper to the individuals, consumers, and to the public at large through the claimed invention.

It is another object of the invention where the retailer or wholesaler advertises to the public through radio advertising, television advertising, internet advertising, newsprint advertising, in-store advertising that the business barter groceries and or other goods for silver or gold coins, or tokens, or bars, or bills.

It is another object of the present invention where the BARTERED VALUE is NOT an asset-backed currency, or even a currency at all, but rather a BARTERED VALUE that is numeric, or alphanumeric, or binary code.

It is another object of the present invention to create a business-app, or computer-app, or internet-app, or web-app, or website-app that allows the customer to quickly and easily initiate said BARTER TRANSACTION or said BARTER TRANSACTION FORM with said business.

It is another object of the present invention the applicant claims the word to describe BARTERED VALUE is “BART” in singular form and “BARTS” in plural form, and is NOT a Trademark or a trade name, anymore than the word “dollar” is to describe the FRN currency, and where on an International computer keyboard the abbreviation for “BART” is symbolized as the key capital #which is just left of the capital key showing $. For example 68 Barts would be displayed as 68 # or #68.

It is another object of the present invention for said business is a financial advantage to use the method of the present invention wherein the individual does not want to exchange their coins, tokens, bars, or bills, made of gold or silver, for FRNs in a SALES TRANSACTION, for reasons already explained, but instead the individual wants to receive or use, as an intermediate step, a BVC or BVT having been assigned the BARTERED VALUE during the BARTER TRANSACTION where the BARTERED VALUE can be used immediately or used over time to complete the BARTER TRANSACTION which results in a substantial savings to said business because their was no exchange, or outlay in FRNs, by said business, which favorably impacts the retailer's or wholesaler's financial cashflow.

It is another object of the present invention where said business uses electronic communication network devices, at the authorized customer service counter, specially programed and connected to the internet to facilitate a quick, efficient, and easy means for the individual and said business or its authorized affiliate, to transact bartering of groceries and other goods for coins, tokens, bars, and bills, made of gold or silver.

It is another object of the present invention to improve the functionality of the “TECHNICAL FIELD” of the claimed invention pursuant to MPEP 2106.05(a) where the claimed invention improves the “technical field” by solving the cited TECHNOLOGICAL PROBLEMS identified in the Specification and where the “claims” cites the TECHNOLOGICAL SOLUTION. MPEP 2106.05(a) states: “This consideration has also been referred to as the search for technological solution to a technological problem”. See e.g., DDR Holdings, LLC. v. Hotels.com, L.P., 773 F.3d 1245, 1257, 113 USPQ2d 1097, 1105 (Fed. Cir. 2014); Amdocs (Israel), Ltd. v. Openet Telecom, Inc., 841 F.3d 1288, 1300-01, 120 USPQ2d 1527, 1537 (Fed. Cir. 2016).

It is another object of the present invention to provide “SUBSTANTIATING EVIDENCE OF A SOURCE OF A PROBLEM” in the specifications and by separate Sworn Declarations that the applicant has alleged he discovered concerning the claimed invention pursuant to MPEP 2106.05(a).

It is another object of the present invention to show how the BVC, or BVT, or BVMD, and the “closed-loop electronic communications network system” can be programed using a special computer-implemented program to process BARTER TRANSACTION from beginning to end without the use of FRN currency, or a currency authorized by the United States, or its successor, and without involvement of a Federal Reserve bank or financial institution during the BARTER TRANSACTION.

It is another object of the present invention to provide a business method for bartering coins, tokens, bars, and bills made of gold or silver for a BARTERED VALUE CARD (BVC), or its equivalent, having been assigned ‘BARTERED VALUE’, or its equivalent, during the BARTER TRANSACTION, that can be used on a computer-implement closed-loop electronic communications network system of said business and where said customer can exchange said BARTERED VALUE for other “goods” (aka: “Gift Cards or Prepaid Cards of other retailers, or wholesalers, or stores, or restaurants that are on a different closed-loop electronic communications network system or are on an open-loop electronic communications network system, such as MasterCard® or VISA® card”). A BARTERED VALUE CARD (BVC) issued by Sam' Club®, for example, which is a wholesaler that sells groceries and other “goods” where the individual could barter gold or silver coins having a bartered value, equivalent of today's value of the $5,000 (FRN currency). So what “goods” could the customer obtain during his BARTER TRANSACTION?He could obtain: food, groceries, clothing, tires, gasoline, motor oil, books, office supplies, cleaning supplies, pots and pans, alcohol, computers, printers, office supplies, and much more and hundred different company's GIFT CARDS that operated on their own closed-loop electronic communications network system, such as Home Depot®, Lowe's®, Red Lobster®, McDonalds®, Olive Garden®, Chipotle®, Saks®, Dillards®, Macy's®, Nordstrom®, Kohl®, JC Penny®, and said BVD and its BARTERED VALUE can be exchanged for “goods” known as a VISA® CARD, or a MASTER CARD® that works on a open-loop electronic communications network system and can be used at the doctor's office, the dental office, airlines, to purchase just about anything. Therefore BARTERED VALUE assigned to a BVC, or a BVT, or a BVMD can be used, in place of FRN currency to acquire these “goods”.

It is another object of the present invention to provide a computer-implemented special electronic computer program that performs the STEPS of said BARTER TRANSACTION from initiation to completion where said business knows the comparison between the profit of said barter transaction and what the profit would have been had the transaction been for FRN currency instead, for tax purposes and business evaluation purposes.

It is another object of the invention where the BVC does not fall under the rules set by the Federal Trade Commission (FTC), or the U.S. Government that regulates, or controls, or restricts, Gift Cards, or Prepaid Cards, or Stored-Value Cards, because the Bartered Value assigned to the BVC never involves Federal Reserve Note (FRN) currency, or CBDC.

It is another object of the present invention to create a user friendly and interactive website, or web-app, or webpages where the individual using the internet can connect to the website, or webpage(s), or web-app of said business or its authorized affiliate(s) and can quickly and easily select or identify his or her coins, and or tokens, and or bars, and or bills that the retailer or wholesaler, or its authorized affiliate accepts in barter and can obtain a Barter Offer, or Barter Value, or Bartered Offer, or Bartered Value in one or more, interactive STEPS, or electronic communication transmissions between said business, or its authorized affiliate, and said individual to facilitate said barter transaction.

It is another object of the present invention to create an opportunity for said business and said individual to share in any potential increased profits where the price of the bartered silver or gold coins, and the alike, had increased in value after the ‘Bartered Value’ had been determined and agreed upon and assigned to said BVC, but before the individual had used all of the ‘Bartered Value’ assigned to said BVC, where said business could assign additional ‘Bartered Value’ automatically, to said BVC, and notify said individual of such change through their email by using the information obtained on said BTF.

It is another object of the present invention to enter into the closed-loop electronic communications network system having the completed and filed BTF a cross-reference tag number or barcode label on the sealed bag that is thereafter dropped through the counter slot and through a corresponding slot into the closed security safe. So when the security safe is opened and the labeled, or tagged, or barcoded bag, containing the bartered items from said barter transaction is retrieved from the security safe it can be quickly identified, scanned, recorded, and cross-referenced to the barter transaction and BTF, or its equivalent.

It is, yet, another object of the present invention to have a computer-implemented software program to provide a secure method of the present invention to safeguard against any mistake or misrepresentation of the bartered items by the individual and or authorized employee or accident or theft at the authorized customer service counter by electronically recording several security features such as: (1) electronic surveillance by one or more cameras which records and retains photos or video of said barter transaction(s), (2) electronically weighing coin, token, bar, using an electronic weight scale that is connected by electronic communication network that automatically compares and records actual scale weight versus specified weight according to declared coin(s), token(s), bar(s) on said BTF, (3) performing a PING test using a special computer program app—(Google: “PINGCOIN”). Where a microphone records the Ping Test connected to said electronic communications network that listens to the PING performed during the inspection phase by the authorized employee or agent to electronically confirm, automatically, that PING vibration sound matches that specified for the coin, or token, or bar, on the BTF where said PING TEST is displayed and recorded on the computer screen for acceptability or rejection. Silver coins and tokens in particular has a very definite PING vibration or sound and when recorded can easily be identified as being real or counterfeit. This inspection test, along with other tests, can be automatically be recorded and filed against said BTF using custom or special computer program.

### BRIEF DESCRIPTION OF THE DRAWINGS

The drawings are provided to illustrate certain embodiments described herein. The drawings are merely illustrative and are not intended to limit the scope of claimed invention and are not intended to show every potential feature or embodiment of the claimed invention. The drawings are not necessarily drawn to scale; in some instances, certain elements of the drawing may be enlarged with respect to other element of the drawing for purposes of illustration.

FIG. 1 illustrates an embodiment of the present invention where a grouping of a coin, token, bar, and bill, made of silver or gold, which can be bartered, individually or as a group, for groceries at a retailer or wholesaler (aka: “business”) with an intermediate step of involving the use of a Barter Value Card (BVC) (aka: “magnetic stripe card:) issued by the business.

FIG. 2 illustrates an embodiment of the present invention showing electronic communications system devices allowing said individual to electronically communicate and initiate and transact a barter transaction between said individual and said retailer or wholesaler, or its authorized affiliate.

FIG. 3 illustrates an embodiment of the present invention which is an example of BARTER TRANSACTION FORM (BTF) that can be displayed on a internet site of said business webpage of a website, or web-app, in many different formats, of the retailer or wholesaler, or its authorized affiliate, showing a quick and convenient method whereby the individual can enter into a ‘barter transaction’ by initiating and forwarding said BTF, or the alike, to said retailer or wholesaler, or its authorized affiliate by the internet or email said BTF to obtain,

FIG. 4 illustrates an embodiment of the BARTER TRANSACTION FORM (BTF).

FIG. 5 illustrates an embodiment of claim 1 of the present invention.

FIG. 6 illustrates a continuation of the embodiment of claim 1 of the present invention.

FIG. 7 illustrates a continuation of the embodiment of claim 1 of the present invention.

FIG. 8 illustrates an embodiment of the “technical field” of the invention.

### DETAILED DESCRIPTION OF THE DRAWINGS

The invention now will be described more fully hereinafter with reference to the accompanying drawings, which form a part hereof, and which show, by way of illustration, specific embodiments by which the method of the invention may be practiced by and between said business and said individual. This invention may, however, be embodied in many different forms and should not be construed as limited to the embodiments set forth herein; rather, these embodiments are provided so that this disclosure will be thorough and complete, and will fully convey the scope of the present invention to those skilled in the art. The following detailed description is, therefore, not to be taken in a limiting sense.

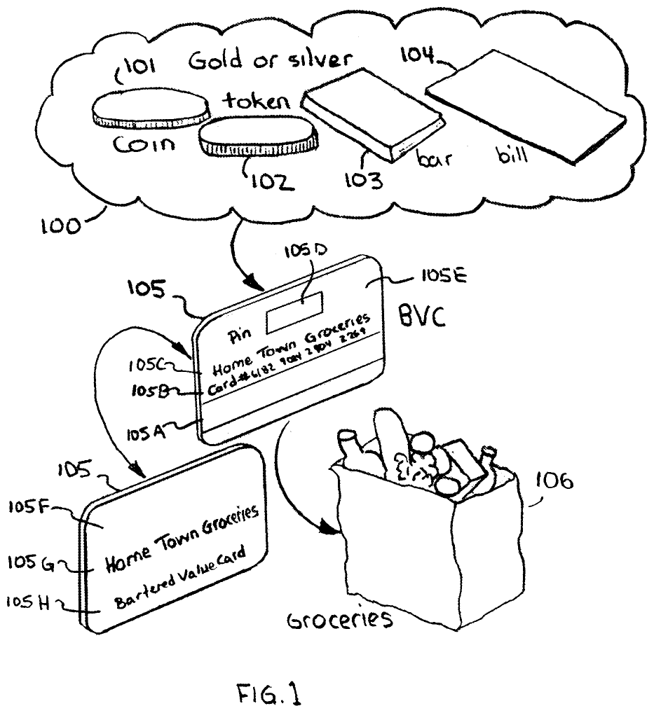

FIG. 1 illustrates an embodiment of the present invention of silver and gold items 100 to barter that include a coin 101, a token 102, a bar 103, and a bill 104. Where the coin 101 represents any government issued gold or silver coin 101, usually containing one troy ounce of either gold or silver. The U.S. Mint makes or mints 1 oz silver American Silver Eagles coins stamped with a $1 face value, but is currently being sold for approximately $30 through their “Authorized Purchasers” which are select coin dealers or coin distributors in the United States. The silver content of an American Silver Eagle is 0.999 purity. The U.S. Mint also makes or mints 1 oz gold American Gold Eagles coins stamped with a face vale of $50, but is currently being sold for over $2,000 through their “Authorized Purchasers”. So in effect, the public has to pay 30 times the face value for their American Silver Eagle coins, while the public has to pay more than 40 times the face value for American Gold Eagle coins. Yet, the usmint..gov website states: “Congressionally authorized, American Eagle Bullion Coins are minted and issued by the United States Mint. They are intended to provide investors with convenient and cost effective way to invest in precious metal’” Token 102 (or rounds as they are commonly known as) is also made of silver or gold and it too is generally made of 1 troy oz. with 0.999 fine silver content or a gold content of 0.9167. The difference between a token 102 and a coin 101 is the coin 101 is made or minted by an official governmental entity or agency while a token 102 or round is minted or made by a private mint or manufacturer. Tokens (or rounds) are never stamped with a face value and are sold for its precious metal content by weight which is normally expressed in Troy OZ. Although the U.S. Mint states: their coins “are intended to provide investors with convenient and cost-effective way to invest in precious metals” it is proven that silver tokens or rounds are a much more “cost effective way to invest in precious metals” as they are always substantially less in price or cost and more readily available than the U.S. Mint silver and golds coins are. Silver token 102 are usually made of 1 Troy oz. of silver, while the gold coins usually are offered in 1 oz, ½ oz, ¼ oz, and 1/10 oz weights. The Royal Canadian Mint, and Australian Mint, the South African Mint and several other countries offer their coins in the same weight demonization. Privately minted silver and gold token 102 (or rounds) are extremely popular with many individuals as they believe why should one pay more for the same weight of precious metal content. If one is buying for their precious metal content why should one pay more for a coin than a token if both are made containing one ounce or one Troy ounce of silver or gold?Gold or silver bar 103 (or bullion as they are commonly called) are mainly minted by private mints where the bar weight for silver is usually—1 oz., 5 oz., 10 oz,. 100 oz., or 1000 oz. for silver and for gold—1 gram, 2 grams, 2.5 grams, 5 grams, 10 grams, 20 grams, 50 grams, 100 grams, 250 grams, 500 grams, 1 oz., 10 oz . . . Bill 104 are relatively new (Google: ‘Goldback’) and are made of 0.999 fine gold by using a vacuum technology of applying atomized gold particles of 24KT to a flat thin plastic BOPP film, with another protective plastic film layer to create a gold lamented (or sandwiched) bill 104 and are offered in 1/1000th oz, 1/500th oz. bill, 1/200th oz. bill, and 1/100th oz. bill, 1/40th oz. bill, and a 1/20th oz. bill denominations. It should be understood that some said retailer or wholesaler may accept only coins, or only coins and tokens, or only coins, tokens, and bars. all of these options are within the scope of the present invention and may vary from one said retailer or wholesaler to another. This grouping 100 of gold or silver coin, token, bar, and or bill, can be bartered for groceries 106 or other goods 106 using an intermediate step in the barter transaction by said business issuing a Barter Value Card (BVC) 105, being issued by the retailer or wholesaler or its authorized affiliate, and used which shown here are one and the same for illustrative purpose, which can be a magnetic stripe card 105, or mag-stripe card 105, or a magnetic stripe/barcode card (not shown), or mag-stripe/UPC code card (not shown), or a smart-chip card (not shown), smart chip/barcode card (not shown), or a RFID card (not shown), or a smart-chip/UPC card (not shown), contactless RFID card (not shown), or passive transponder chip card or token with or without a mag-stripe (not shown), and or a two-dimensional matrix code card/mag-stripe card (not shown), or the like, each having an unique identifying code, where the BVC 105 can have a mag-stripe 105A or a magnetic stripe 105A having an magnetically embedded code and a related numerical identifying card number or code 105B, where in addition there can be a barcode that also reflects the identifying card number (not shown), and where the BVC 105 further has the name of the issuer or Retailer or Wholesaler 105C (optional) printed on the backside 105E of BVC 105 and where a coating of ink 105D conceals part or all of a PIN number (not shown). On the frontside 105F appears the name of the issuer 105G, or retailer 105G, or wholesaler 105G, and identification of what the card is 105H, and where BVC 105 can be loaded with or assigned ‘Bartered Value’ (not shown), through or by one or more electronic communications devices (aka: card scanner), loaded manually and or electronically, or automatically and or electronically, on or into the closed-loop electronic communications network device located at the authorized customer service counter.

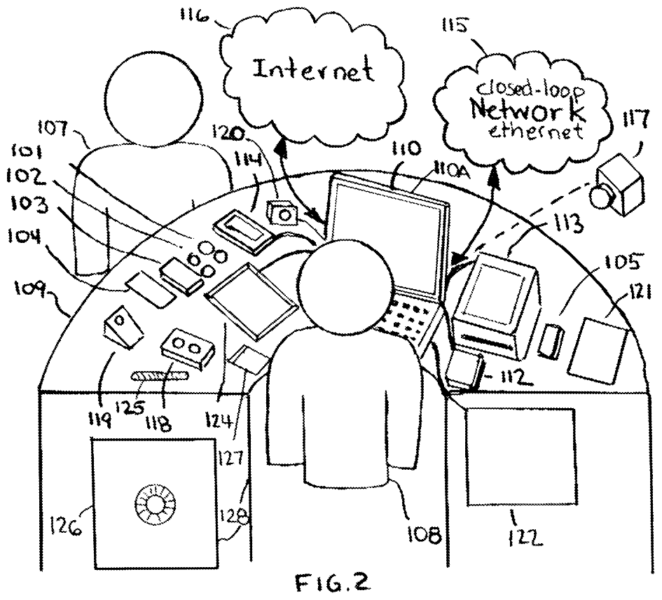

FIG. 2 illustrates an embodiment of the present invention where individual (barterer) 107, goes to the authorized customer service counter 109 of said retailer or wholesaler and presents to the authorized employee 108 with coin 101, and or token 102, and or bar 103, and bill 104 after having initiated a BTF 121, or its alike, on-line using an electronic communication device such as a desk top computer 110B (not shown), or a tablet computer 110C (not shown), or a smartphone 110D (not shown), or a laptop computer 110E (not shown) which by using the internet 116 the individual 107 has sent electronically his or her BTF 121 (or initiated at the customer service counter device 110, which can be displayed before the authorized employee 108 viewing an electronic communications device 110 that is both a closed-loop communications network using ethernet 115 and an device 110 capable of accessing the internet 116 without or with a firewall 116J to prevent unauthorized access to said closed-loop communications system of said business, to assign, or confirm, or reconfirm a current Barter Offer or Barter Value or Bartered Offer or Bartered Value on or associated with and or stated on said BTF 121, or the alike, or electronic communications device 110A (not shown) which is a separate device 110A (not shown) from said closed loop electronic communications device 110 to prevent unauthorized use of device 110, where electronic printer 113 is connected to the electronic communication network device 110 and or 110A (not shown) and where BTF 121 can be printed out and where electronic scanner 124 and electronic scale 124 is connected to device(s) 110 and or 110A and is capable of scanning a magnetic strip 105A or a UPC code (not shown) or barcode 1051 on said BVC 105 and automatically entering it into the closed-loop electronic communication network and system device 110 and where electronic scale 124, or another electronic scale (not shown) is capable of electronically weighing and recording a single coin, or token, or bar, accurately, during the inspection process performed by authorized employee/agent 108 and recording the weight in the device 110 against said BTF 121 using a special computer program (not shown) and where inspection devices like terminal sliding device 119 or coin size gauge 118 is used. Many other inspect methods or devices (not shown) can be used such as: visual inspection, weight inspection, terminal sliding velocity inspection, chemical analysis inspection, size inspection, magnetic test inspection, spectrographic analysis, X-ray analysis, optical emission spectroscopy analysis, spectrometer analysis, drop test analysis, acid test analysis, scratch test analysis, ping test analysis, conductivity analysis, potentiometric analysis, ultrasound analysis, hardness analysis, density test analysis, specific gravity test. Where some of aforementioned test methods can be electronically connected to said electronic communications system where ti can be recorded and retained against said BTF 121, such as the ‘ping test’ which by computer app records the audible sound vibration and automatically accepts or rejects the coin or token or bar bases on the sound waves of said ‘ping test’. Where card reader 112 or card/token reader 112 or card/token reader/writer 112 is connected to electronic communications device 110 and or device 110A. Where camera 117 is electronically connected to device 110 and or 110A as is camera 120 where images (not shown) and or video (not shown) can be recorded, stored, and filed against said barter transaction involving said BVC 105 and or BTF 121. Where images and video recording the actions and moments of the individual and authorized employee or the opening or closing of the safe 126 can be retained against the BTF 121. Where slot 125 on authorized customer service counter 109 is or can be used to drop a tagged or labelled bag (not shown) containing the bartered items coin 101, token 102, bar 103, bill 104 from the barter transaction associated with said BVC 105 and or BTF 121 into safe 126 for safe keeping, where safe 126 has a corresponding slot in the security safes where said bag passes through and into said safe 126 where said safe 126 is electronically connected 128 to closed-loop electronic communications network device 110 so it can be recorded as to when safe 126 has been opened and closed. Located remotely can be a CPU 122 to tie the closed-loop electronics communications devices and system together, where there maybe hundreds or thousands of electronic devices of the business' closed-loop electronic communications network system. Should said individual appear at the authorized customer service with coins, or tokens, or bars, or bills, made of gold or silver without first having filed a BTF, or the alike, on-line then the BTF can be initiated and or completed at the authorized service counter 109 by the business. It should be understood that many different variations, designs, and devices can be used at the authorized customer service counter that all are or should be within the scope of the present invention.

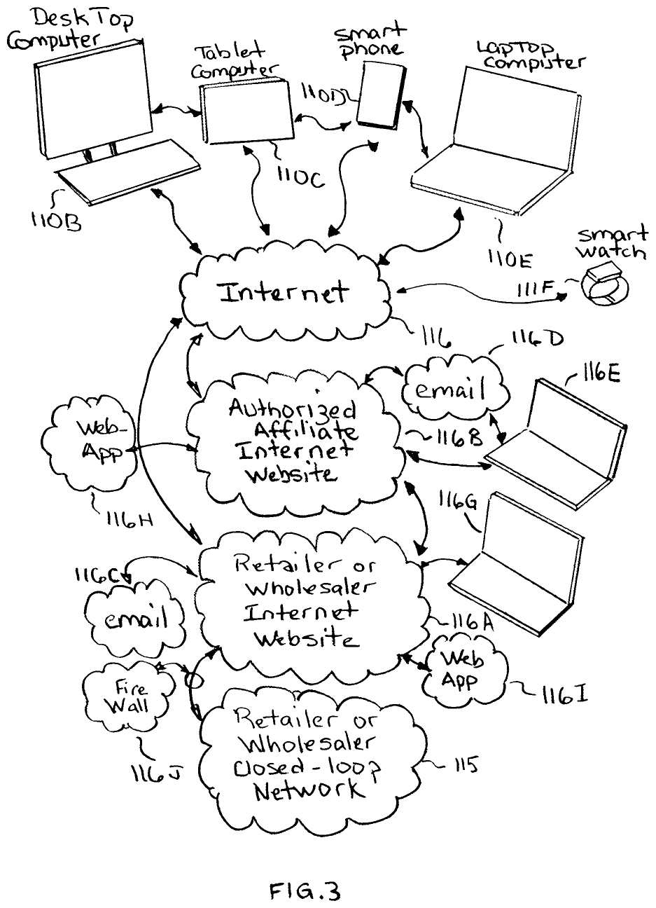

FIG. 3 illustrates an embodiment of the present invention where said individual (not shown) having an desk top computer 110B, or a tablet computer 110C, or a smart cellphone 110D, or a laptop computer 110E, or smart-watch 111F can communicate electronically through an electronic communications system using the internet 116 with said retailer or wholesaler, internet website 116A or web-app 1161, or email 116C, to computer 116G, or communicate using internet 116 with the authorized affiliate's internet website 116B or web-app 116H, or email 116D through their computer 116E where the business' closed-loop electronic communications network system 115 of the retailer or wholesaler is only accessible to the business because of firewall 116J where the business' closed-loop electronic communications network system 115 is an ethernet and or an internet network system.

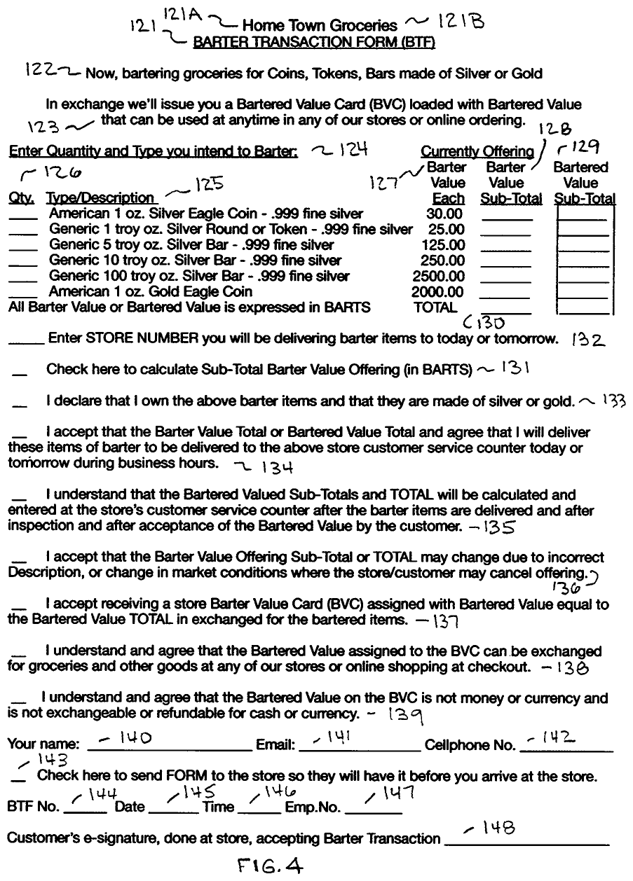

FIG. 4 illustrates an embodiment of the BARTER TRANSACTION FORM (BTF) where said retailer 121A or wholesaler 121B having a internet website 116A or a web-app 1161 or its authorized affiliate having a internet website 116B or a web-app 116H displays a BARTER TRANSACTION FORM (BTF) 121, or the alike, of said business on its webpage 121A or its web-app 121B which announces, or promotes, or identifies, or notifies said individual (barterer), or customer, or consumer that they offer to barter groceries and other goods for coins, tokens, bars, and for bills, made of silver or gold 122 where the individual (barterer—not shown) 107, is instructed to enter on the BTF 121 the quantity 126 and identify or select the “Type” 125 of coin or token or bar after reviewing the current Barter Value offered 127 and the BTF 121 instructs to—“Check here to calculate Total Barter Value” 131, which then calculates automatically the Barter Value Sub-Total 128 and displays a Barter Value Total 130 on said BTF 121 instructs the individual to—“Enter the store number you will be delivering the barter items today or tomorrow” 132 which is published (not shown) on the website or additional webpage (not shown) of the retailer 121A, or wholesaler 121A, and where the BTF 121 requires the individual (barterer) to “I declare that I own the above barter items and they are made of silver or gold 133, to declare the individual” accepts the Barter Value Total and agrees it is based on barterer delivering the above selected items of barter to be delivered to the above store's customer service counter today or tomorrow during business hours” 134, where the BTF 121 further instructs the individual to “understand that the Bartered Value Sub-Total will be calculated and entered at the store's customer service counter after the barter item are delivered and after inspection and after acceptance of the Bartered Value by the customer” 135, where the individual needs to check—“I accept that the Barter Value Offering Sub-Total or TOTAL may change due to incorrect Description, or change in market conditions where the store/customer may cancel offering”. 136 and where the BTF 121 further requires the individual (barterer) to “accept that the Barter Value Card (BVC) assigned with Bartered Value equal to the Bartered Value TOTAL in exchanged for the bartered items”. 137, and where the BTF further requires the individual to check “I understand and agree that the Bartered Value assigned to the BVC can be exchanged for groceries and other goods at any of our stores or on-line shopping at checkout” 138, and also the BTF requires the customer to check “I understand and agree that the Bartered Value is not money or currency and is not exchangeable or refundable for cash or currency”. 139. The BTF 121 includes the customer's name 140, email 141, cellphone no. 142, BTF No. 144, Date 145, Time 146, Employee No. 147, customer's signature 148, and check here to send FORM to the store 143. It should be understood that there are countless ways of making a BTF, or the alike, with countless formats, and countless instructions, and countless required information all should be considered to be within the scope of the present invention.

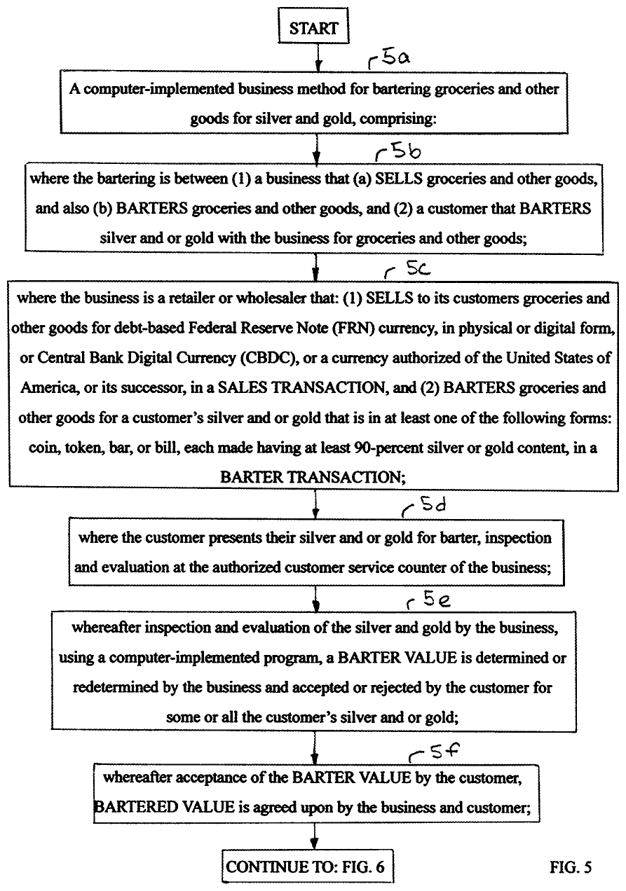

FIG. 5 illustrates an embodiment of claim 1 of the present invention where FIG. 5a states a portion of claim 1: A computer-implemented business method for bartering groceries and other goods for silver and gold, comprising: and FIG. 5b states: where the bartering is between (1) a business that (a) SELLS groceries and other goods, and also (b) BARTERS groceries and other goods, and (2) a customer that BARTERS silver and or gold with the business for groceries and other goods; and FIG. 5c states: where the business is a retailer or wholesaler that: (1) SELLS to its customers groceries and other goods for debt-based Federal Reserve Note (FRN) currency, in physical or digital form, or Central Bank Digital Currency (CBDC), or a currency authorized of the United States of America, or its successor, in a SALES TRANSACTION, and (2) BARTERS groceries and other goods for a customer's silver and or gold that is in at least one of the following forms: coin, token, bar, or bill, each made having at least 90-percent silver or gold content, in a BARTER TRANSACTION; and FIG. 5d states: where the customer presents their silver and or gold for barter, inspection and evaluation at the authorized customer service counter of the business; and where FIG. 5e states: whereafter inspection and evaluation of the silver and gold by the business, using a computer-implemented program, a BARTER VALUE is determined or redetermined by the business and accepted or rejected by the customer for some or all the customer's silver and or gold; and where FIG. 5f states: whereafter acceptance of the BARTER VALUE by the customer, BARTERED VALUE is agreed upon by the business and customer.

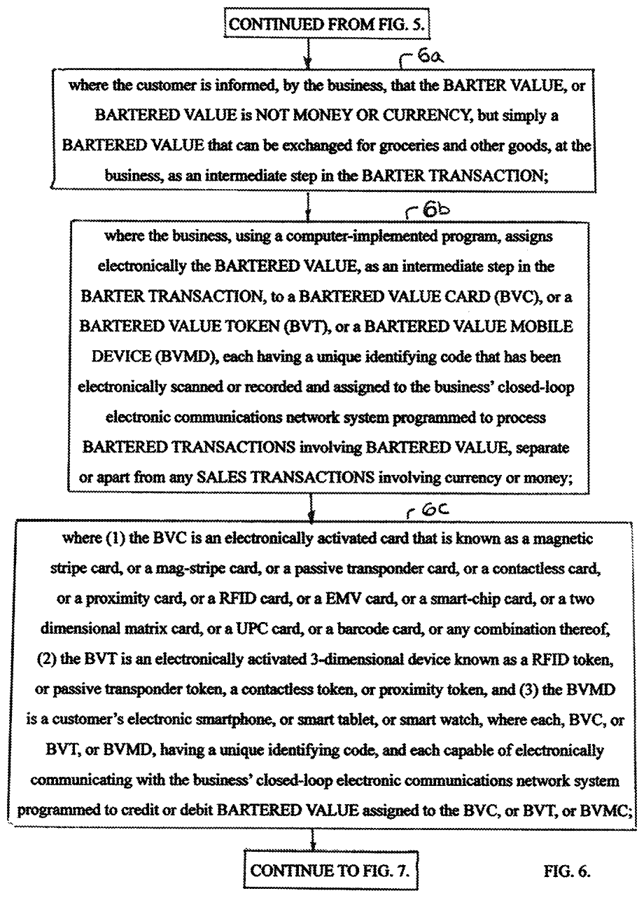

FIG. 6a continues with the embodiment of claim 1: where the customer is informed, by the business, that the BARTER VALUE, or BARTERED VALUE is NOT MONEY OR CURRENCY, but simply a BARTERED VALUE that can be exchanged for groceries and other goods, at the business, as an intermediate step in the BARTER TRANSACTION; and where FIG. 6b states: where the business, using a computer-implemented program, assigns electronically the BARTERED VALUE, as an intermediate step in the BARTER TRANSACTION, to a BARTERED VALUE CARD (BVC), or a BARTERED VALUE TOKEN (BVT), or a BARTERED VALUE MOBILE DEVICE (BVMD), each having a unique identifying code that has been electronically scanned or recorded and assigned to the business' closed-loop electronic communications network system programmed to process BARTERED TRANSACTIONS involving BARTERED VALUE, separate or apart from any SALES TRANSACTIONS involving currency or money; and where FIG. 6c states: where (1) the BVC is an electronically activated card that is known as a magnetic stripe card, or a mag-stripe card, or a passive transponder card, or a contactless card, or a proximity card, or a RFID card, or a EMV card, or a smart-chip card, or a two-dimensional matrix card, or a UPC card, or a barcode card, or any combination thereof, (2) the BVT is an electronically activated 3-dimensional device known as a RFID token, or passive transponder token, a contactless token, or proximity token, and (3) the BVMD is a customer's electronic smartphone, or smart tablet, or smart watch, where each, BVC, or BVT, or BVMD, having a unique identifying code, and each capable of electronically communicating with the business' closed-loop electronic communications network system programmed to credit or debit BARTERED VALUE assigned to the BVC, or BVT, or BVMC.

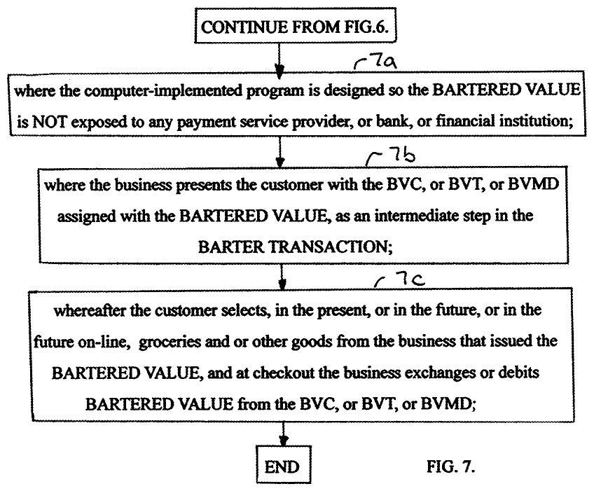

FIG. 7. continues with the embodiment of claim 1: FIG. 7a states: where the computer-implemented program is designed so the BARTERED VALUE is NOT exposed to any payment service provider, or bank, or financial institution; where FIG. 7b where the business presents the customer with the BVC, or BVT, or BVMD assigned with the BARTERED VALUE, as an intermediate step in the BARTER TRANSACTION; and; where FIG. 7c states: whereafter the customer selects, in the present, or in the future, or in the future on-line, groceries and or other goods from the business that issued the BARTERED VALUE, and at checkout the business exchanges or debits BARTERED VALUE from the BVC, or BVT, or BVMD.

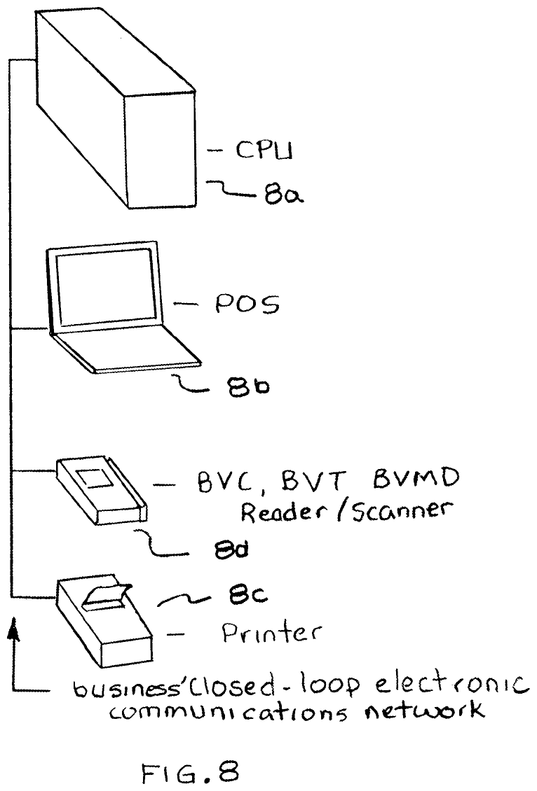

FIG. 8. illustrates the embodiment of the TECHNICAL FIELD of the present invention, where it states TECHNICAL FIELD OF THE INVENTION: Business' closed-loop electronic communication network system with computer-implemented program to process electronic BARTERED VALUE that is NOT digital currency or money, but a digital BARTERED VALUE agreed upon by the customer and the business for the BARTER of the customer's silver and gold for the business' groceries and other goods where the business assigns BARTERED VALUE to a BVC, or a BVT, or a BVMD using the computer-implemented program on the business' closed-loop electronic communication network system where the program does NOT expose the BARTERED VALUE to any payment service provider, or bank, or financial institution, and FIG. FIG. 8a. electronically connected to a CPU having at least one computer-implemented program to perform the function of the computer-implemented method, as shown in the “claims” of the present application, which is connected to FIG. 8b. an Electronic Point-of-Service (POS) computer device, connected to FIG. 8c. an Electronic Printer, connected to FIG. 8d. an Electronic BVC, BVT, BVMD scanner or reader, able to electronically read the unique identifying code on a BVC, BVT, BVMD and enter the code into the business' closed-loop electronic communications network system.

### Definitions

The following words, terms and phrases shall have the meaning or definition expressed below, unless otherwise provided herein, and shall superseded any other definition by any other source. This disclosure may employ other words, terms and phrases not expressly defined herein. Such other words, terms and phases shall have the meanings they would possess within the context of this disclosure to a person having ordinary skill in the art. In some instances, a word, term or phrase may be defined in the singular or plural. In such instances, it is understood that any word, term, or phrase in the singular may include its plural counterpart and vice versa, unless expressly indicated to the contrary.

AUTHORIZED AFFILIATE: a business that is associated and approved by the retailer or wholesaler that BARTERS groceries and other goods, but not owned or wholly owned by the retailer or wholesaler and is authorized by said retailer or wholesaler to handle on-line processing of the Barter Transaction Form (BTF), or other form(s) and related matters concerning BARTER TRANSACTION(S) with an individual or customer.

AUTHORIZED CUSTOMER SERVICE COUNTER: a service counter at the business that has been approved or designated by said business as the location to conduct in-store BARTER TRANSACTIONS involving silver and gold.

BANKNOTE or NOTE: (aka: Federal Reserve Note—FRN): flat usually rectangular piece of cotton and linen, by a Country as money (that can be used to pay taxes), constituting a central bank's promissory note, or I.O.U., to pay a stated amount to the bearer on demand, but, in fact today is irredeemable for any thing other than itself as “Legal Tender”, since gold and silver backing or exchangeability has been eliminated. The FRN has been designated by the U.S. Government or the Federal Reserve to be a: “note that is legal tender for all debts, public and private”.

BANKSTER: a banker that is a member of the Federal Reserve Banking Cartel that creates electronic digital Federal Reserve Note currency out of nothing and assigns it electronically to a computer as currency, then charges interest on that debt-based currency, which they loan into existence, which under the laws of the United States Government, no one other than a “bankster” or banker” is permitted under law to do, to protect the MONOPOLY interests of this “cartel”.

BARTER, BARTERING, BARTER TRANSACTION: The act of exchanging one good or service for another, between two parties, without the exchange of currency or money.

BARTER, BARTERING, BARTER TRANSACTION: The act of exchanging groceries and other goods at a business that is a retailer or wholesaler that barters groceries and other goods for an individual's silver and gold using an intermediate STEP where a BARTERED VALUE CARD (BVC), or a BARTERED VALUE TOKEN (BVT), or a BARTERED VALUE MOBILE DEVICE (BVMD) is assigned digital BARTERED VALUE that is NOT currency or money where the BARTERED VALUE assigned to the BVC, or BVT, or BVMD can be exchanged for groceries and other goods.

BARTER TRANSACTION FORM (BTF): any electronic or hard copy form, or receipt, or record of at least part of the BARTER TRANSACTION, initiated by the business or its authorized affiliate, where the BTF identifies, at a minimum, the customer by name, the customer's cellphone number and or email address, and the quantity and type of silver and gold coins, tokens, bars, or bills offered for barter or accepted for barter.

BARTERED VALUE (BV): a non-currency or non-money VALUE designated by a numeric code, or alphanumeric code, or binary code and agreed upon by the Barterers as VALUE during a Barter Transaction, which is not a representation of a debt-based currency or money, or a Country's currency, or FRN currency, or a Central Bank Digital Currency (CBDC) and which is determined and agreed upon, during the barter transaction between said business and said individual (aka: customer), where one at least one physical good from one party (barterer), such as groceries and or other goods is/are being bartered or exchanged by said business, for another, at least one, physical good of another party, such as silver or gold coins, or the alike, possessed by an individual (customer), where the BARTER VALUE has been accepted and agreed upon by both parties, which thereafter becomes a digital BARTERED VALUE (BV), and thereafter as an intermediated STEP, during the BARTER TRANSACTION, a BARTERED VALUE CARD (BVC), or BARTERED VALUE TOKEN (BVT), or BARTERED VALUE MOBILE DEVICE (BVMD) is issued, or re-issued, or assigned by said business having been assigned BARTERED VALUE.

BARTERER: an individual or business who trades or exchanges one physical commodity, such as groceries and other goods, for another, such as gold and or silver in the form or coin, token, bar, and or bill, without using an approved currency of the United States of America, or its successor, or Federal Reserve Note (FRN) currency, or CBDC currency, or its electronic representation, or vice versa.

BARTER VALUE CARD (BVC) is typically a flat plastic card that has been assigned a unique numerical, or alphanumerical, or binary code that can be read by an electronic scanner or card reader and can be assigned BARTERED VALUE using a closed-loop electronic communications network device of the retailer or wholesaler and where the BVC is commonly known as a magnetic stipe card, a mag-stripe card, a contactless card, or passive transponder card, or a proximity card, or RFID card, or a chip card, or a smart chip card, or a UPC Code card, or a barcode card, or a two-dimensional matrix code card, or any combination thereof, or its equivalent, with or without a PIN number, where a Bartered Value, can be assigned and stored on or associated with said BVC where said Bartered Value can be processed or stored on the closed-loop electronic communications network system of said retailer or wholesaler where the computer-implemented program prevents the BARTERED VALUE from being exposed to a payment service provider, or bank, or financial institution.

BARTERED VALUE MOBILE DEVICE (BVMD) a cellphone, or smart phone, or smart tablet, or smart watch, or communications device having an unique identifying code cable for transmitting a BARTERED VALUE to said business' closed-loop electronic communications network device for the purpose of crediting or debiting BARTERED VALUE in a BARTER TRANSACTION.

BARTERED VALUE TOKEN (BVT) typically a three-dimensional token that has been assigned an unique numerical, or alphanumerical, or binary code that can be read by an electronic scanner or token reader and can be assigned BARTERED VALUE using a closed-loop electronic communications device of the retailer or wholesaler and where the BVT is commonly known as a passive transponder token, or contactless electronic token, smart chip token, where BARTERED VALUE can be possessed or stored on the closed-loop electronic communications network system of said retailer or wholesaler.

BUSINESS: a physical retailer or wholesaler, that have a few or thousands of stores within their franchise, that engages in conducting SALES TRANSACTIONS that involve selling food, groceries and other goods for a Country's currency, such as the debt-based, fiat Federal Reserve Note (FRN) currency, or its successor, or a Central Bank Digital Currency (CBDC), and where the retailer or wholesaler is also engaged in conducting BARTER TRANSACTIONS that involve bartering food, groceries and other goods for silver and gold in the form of coin, or token, or bar, and or bill without the exchange of a Country's currency or CBDC, where the business issues BARTERED VALUE as an intermediate step in the BARTER TRANSACTION.

CENTRAL BANK DIGITAL CURRENCY (CBDC) a debt-based digital currency or money of a privately owned Central Bank designed to replace the dying debt-based, fiat Federal Reserve Note (FRN) currency that will be issued soon as “Legal Tender”, but is in fact a debt-based instrument known as a digital I.O.U. CBDC.

CLOSED-LOOP ELECTRONIC COMMUNICATIONS NETWORK SYSTEM: is a technical field of electronically activated devices a Central Processing Unit (aka: CPU), a proprietary electronic communications network system, of said business where the a-special computer program is-capable of processing (1) a SALES Transaction, involving Country's currency or money, using at least one special computer program, and (2) a BARTER Transaction, involving BARTERED VALUE which is NOT $ a a Country's currency or money, where said NETWORK SYSTEM using a special computer program is able to perform inventive method where the Barter Transaction is kept separate from a Sales Transactions, using at least one special computer program, to make the Transaction FUNCTION according to the “inventive method”, where the SALES Transaction on said NETWORK SYSTEM is settled by the individual (1) paying by cash, or $, or dollars, or coins, or credit card, or gift card, or prepaid card (where all are transacted and settled in Federal Reserve Note currency in physical or electronic form), or Central Bank Digital Currency (CBDC), or currency of the United States of America, or its successor, or another Country's currency in electronic form, or (2) said BARTER TRANSACTION on said NETWORK SYSTEM is settled by the individual exchanging BARTERED VALUE, which is NOT a Country's currency, or CBDC, assigned to a BARTERED VALUE CARD, or BARTERED VALUE TOKEN, or BARTERED VALUE MOBILE DEVICE, and or CLOSED-LOOP ELECTRONIC COMMUNICATIONS NETWORK SYSTEM, through a special computer program is able to separate, record, track, and identify the BARTER TRANSACTION separate from a SALES TRANSACTION involving a Country's currency or Central Bank Digital Currency (CBDC) and where the “closed-loop electronic communications network” is connected to one or more electronic devices that are programed to make said “NETWORK” FUNCTION according to the dictates of said “inventive method”, as stated in the “claims”, and be secure from unauthorized access and to process both the SALES TRANSACTIONS of groceries and other goods for a Country's currency and BARTER TRANSACTIONS of groceries and goods for BARTERED VALUE that is NOT a Country's currency, so that proper reporting to the Internal Revenue Service (IRS) can be done where SALES TRANSACTIONS are separated from BARTER TRANSACTIONS, or vice versa.

COMPUTER-IMPLEMENTED BUSINESS METHOD: is a method for business which is carried out using at least one computer having at least one computer program comprising instructions to execute the given method utilizing certain electronically activated devices to perform the prescribed method. The claimed method is directed to a specific technical field of endeavor and that the claims recite concrete technical steps that are directed to an inventive method of achieving the technical solution to a technical problem where the abstract idea or judicial exception is integrated into a “practical application” and the “inventive concept” yields “significantly more” that transforms the abstract idea into “patent eligible subject matter”.

COMPUTER-IMPLEMENTED INVENTION (CII)—an invention which is directed to a process that includes at least one computer that is programmed to perform a given process (aka: “method”) wherein at least one feature or element is realized by means of a special computer program.

COUNTRY: a nation with its own government that collects taxes.

CORRUPT: having or showing a willingness to act dishonestly, such as in reference to the privately-owned Federal Reserve Banking Cartel which issues Federal Reserve BANKNOTES (97% in digital form) where on the face of each BANKNOTE (3% in physical form) states: “THIS NOTE IS LEGAL TENDER FOR ALL DEBTS, PUBLIC AND PRIVATE”. This is a knowingly dishonest action and statement or oxymoron as a FEDERAL RESERVE NOTE (“BANKNOTE”) is a digital I.O.U., which is a debt instrument and as such cannot be used to payoff another DEBT. DEBT instrument, such as a digital I.O.U. Federal Reserve Note, created by a Federal Reserve banking member, cannot be used to payoff another DEBT, and to claim so is therefore corrupt.

CURRENCY: a system of money in use in a particular country, such as the United States where the coins are issued by the United States government and where the privately-owned Federal Reserve has a monopoly on the physical bill and digital form of money, known as Federal Reserve Note (FRN) currency that are deemed by the U.S. Government to be “legal tender for all debts, public and private”, including taxes, and are identified by $, cash, money, currency, Federal Reserve Note (FRN), or Central Bank Digital Currency (CBDC), where FRN currency, today, is 97-percent in digital form, today.” Federal Reserve Note currency is an I.O.U. form of debt-money.

EVALUATE: the making of a judgment about the amount, number, or value of something, using protocol established by said retailer, or wholesaler, or its authorized affiliate.

EXCHANGE: the act of barter or transferring ownership of one tangible thing for receiving another tangible thing in return, such as gold or silver coin for groceries without the use of currency or money.

FEDERAL RESERVE BANK system or cartel is a privately-owned Central Bank that was Chartered supposedly by the United States on Dec. 23, 1913 where it took control of the monetary system from the U.S. Department of Treasury for its profit and pleasure.

FIAT COIN: a flat, typically round piece of metal or slug made of base metal(s), with an official stamp or impression of a Country, including a stamped numerical value that is accepted or declared by government decree at the stamped value and used as “Legal Tender” money or a medium of exchange of a Country.

FIAT MONEY: is physical or digital currency made by or for a government and distributed by privately-owned central banks, such as the Federal Reserve Note (FRN) or government, and decreed by a government to “be legal tender for all debts, public and private”, including taxes and is not redeemable by the U.S. Government or Federal Reserve Banks for silver or gold.

FRN: an abbreviation for Federal Reserve Note (FRN), authorized under the 1913 Federal Reserve Act, and subsequent changes which was an asset-based currency note redeemable in silver or gold coin, between 1914-1933, but since 1934 is a debt-based, fiat-currency I.O.U. Note of the United States of America controlled by the privately-own Federal Reserve banking cartel.

FUNCTION: work or operate in proper or particular way.

FUNCTIONALITY: the quality of being suited to serve a purpose well.

GOLD BAR: a typically rectangular piece of thick metal in the shape of a bar or ingot made of at least ninety-percent gold with a impression typically on one side that includes an impression or stamp showing weight of the bar, typically: 1 gram, 2.5 grams, 5 grams, 10 grams, 20 grams, 50 grams, 100 grams, 1 oz., 5 oz., 10 oz., 10 oz., 1 Kilo and are often called or known as bullion.

GOLD BILL: a flat, typically thin rectangular plastic film bill where gold, made least ninety-percent gold, is attached, or laminated, or coated to at least one layer of plastic film creating a bill. See U.S. Pat. No. 5,120,589

GOLD COIN: a flat, typically round piece of metal made of at least ninety-percent gold, with an official stamp or impression of a Country's name and or is issued by for a Country, including a stamped numerical monetary value that may have been used as money in the past, but today is not valued, bartered, sold or exchanged, at the stamped numerical monetary value today.

GOLD TOKEN: a flat, typically round or rectangular piece of metal made of at least ninety-percent gold with a impression on one or both sides that includes an impression showing weight of the token and is minted, made, or sold by a private mint or company and is referred to as a gold“round” or “token” and not as money as no monetary value is stamped on the token.

GROCER: “business selling food or other groceries and other goods for the home, or individual(s), or company”, “a person who owns or works in a store that sells general food supplies and certain non-edible articles of household or personal use.”

GROCERIES AND OTHER GOODS: any food product, or any other goods that are sold or bartered at a retailer or wholesaler store or chain, including gasoline, tires, gift cards, or any other tangible goods.

INDIVIDUAL: is a particular person or customer of said business.

INTERMEDIATE: (1) being, situated, or acting between two points, stages, or things (source dictionary..com), (2) being between two other related things, levels, or points (source: dictionary.cambridge..org), (3) being or occurring at the middle place, stage, or degree or between extremes” (source: meriam—webster..com). Example: During a barter transaction where as an step a BARTERED VALUE CARD (BVC) or BARTERED VALUE TOKEN (BVT) is issued or re-issued by a retailer or wholesaler to an individual where BARTERED VALUE has been assigned to said BVC or BVT, as an step, during the BARTER TRANSACTION.

INTERNET: World Wide Web computer network providing a variety of information and communication consisting of electronically interconnected networks using standardized communication protocols that connects and communicates with computers, smart phones, smart watches and other electronic devices to create a World Wide Web computer network system.

MOBILE APP is a computer program or software application designed to run on a mobile device, or BARTERED VALUE MOBILE DEVICE (BVMD) such as a smartphone, smart tablet, or smart watch where the BVMD can process crediting or debiting BARTERED VALUE from the BVMD for the purpose of BARTER TRANSACTION with said business.

MONEY: Is currency that is authorized by a Government or Country where it is claimed to be “legal tender for all debts, public and private”, including taxes as declared by an authorized Government or Country in the form of banknotes, or coin, or digital representation thereof.

NATION: A Country that is controlled by a government that collects taxes using its own currency.

ON-LINE: the individual and retailer or wholesaler, or their authorized affiliate, through a computer device, or smartphone device connects to and or communicates using the internet (world wide web) or ethernet network.

PAYMENT SERVICE PROVIDER (PSP): a company that facilitates electronic payment transactions in FRN currency in digital form between a business and a bank or financial institution.

PHOSITA: a person having ordinary skill in the art as defined by the USPTO.

PONZI SCHEME is a scheme named after Charle Ponzi, who duped investors in the 1920's with a postage stamp speculation scheme and where today the Federal Reserve Banking cartel is duping citizens of the United States into believing that the Federal Reserve dollar has intrinsic value when the Federal Reserve is operating a SCHEME designed to defraud citizens of the United States where they create an ever increasing amount of Federal Reserve MONOPOLY MONEY, designed to increasingly destroy the value of each existing Federal Reserve dollar, guaranteeing the FRN currency to go from being worth less to being worthless over time, because the Federal Reserve constantly adds more currency at an ever increasing rate which inflates away the value of the currency by intent and design. The Federal Reserve would like people to believe that the U.S. Government creates money when Federal Reserve Banks and Central Banks create digital dollars (97%) at essentially no cost other than to destroy the value of the only currency authorized to be used in the United States. President Washington over 200 years ago forewarned us that “Paper Money [or today's digital equivalent] is founded upon fraud and knavery”.

Federal Reserve Governor—Ben Shalom Bernanke: “The U.S. Government has a technology, called a printing press—or today, its electronic equivalent—that allows it to produce as many U.S. dollars as it wishes at essentially no cost”. Bernanke was wrong, it is the Federal Reserve banking cartel that has the [computer]“technology” . . . “that allows it to produce as many [Federal Reserve] dollars as it wishes at essentially no cost”.

PROTOCOL: a system or method of rules or procedures set by business for personnel to follow when transacting barter or sale of groceries and other goods

REEVALUATE: to make a new or revised valuation, or Barter Value of coin(s), token(s), bar(s), or bill(s) made of silver or gold, using protocol established by the retailer or wholesaler or its authorized affiliate.

RE-ISSUE: where the BVC, BVT, or BVMD once assigned or issued to the individual with BARTERED VALUE and where the BARTERED VALUE has been depleted or nearly depleted can be reloaded or reassigned or re-issued new BARTERED VALUE by repeating the STEPS or method in claim 1.

RETAILER: a business or merchant that sells food and other groceries and goods for money or currency, authorized by the United States Government, or its successor, and who also barters food, and other groceries and goods for a customer's silver or gold in the form of coins, tokens, bars, and or bills.

SILVER BAR: a typically rectangular piece of thick metal in the shape of a bar or ingot made of at least ninety-percent silver with a impression typically on one side that includes an impression or stamp showing weight of the bar, typically 1 oz., 5 oz., 10 oz., Kilo, 100 oz., 1000 oz. and are often called, or are known as bullion.

SILVER BILL: a flat, typically thin rectangular plastic film where silver, made of at least ninety-percent silver, is attached, or laminated, or coated to at least one layer of plastic film creating a bill. See U.S. Pat. No. 5,120,589

SILVER COIN: a flat, typically round piece of metal made of at least ninety-percent silver, with an official stamp or impression of a Country's name and or is issued by a Country further including a numerical monetary value that may have been used as money in the past, but today is not valued, or bartered, or exchanged, or sold at the stamped numerical monetary value.

SILVER TOKEN: a flat, typically round or rectangular piece of metal made of at least ninety-percent silver with an impression on one or both sides that includes an impression showing weight of the token and is minted, made, or sold by a private mint or company and is currently referred to as a silver “round” or “token” and not as money as no monetary value is stamped on the token.

SMARTPHONE: A cellphone capable of linking to and communicating via the internet.

COMPUTER PROGRAM: A program run on a electronic computing device designed to process BARTERED VALUE on a business' closed-loop electronic communications network system apart from SALES TRANSACTIONS involving money or currency and where the program processes BARTERED VALUE and performs the functions of the STEPS or METHODS detailed in the CLAIMS whereby BARTER TRANSACTIONS are processed without the use of currency or money of any Country and where the program is designed to process BARTERED VALUE on the business' closed-loop electronic communications network system where the BARTERED VALUE and BARTER TRANSACTION is NOT exposed to a payment service provider, or bank, or financial institution.

TECHNICAL FIELD or TECHNOLOGICAL FIELD: electronically activated devices that are connected or networked together to form a computer NETWORK to process BARTERED VALUE, to circumvent having to process currency or money in a BARTER TRANSACTION, including: (a) access to an electronic communications network connected to ethernet and/or the internet, (b) business' closed-loop electronic communications network system, having one or more: Central Processing Unit (aka: CPU), computer with special computer program, electronic Point-of-Service (POS) device, electronic printer, electronic, scanner or reader, a BVC, and/or BVT, and/or BVMD, each having an unique identifying code, an optional electronic signature pad, where a special computer program functions to make the cited electronic devices perform the inventive method.

TECHNICAL PROBLEM: a problem that involves technology.

It will be apparent to those skilled in the art that modifications may be made without departing from the spirit and scope of the disclosure stated above. Many variations, combinations, and modifications of the applications disclosed here above are possible and are within the scope of the disclosure. Accordingly, the scope of protection is not limited by the description set out above, but is defined by the claims which follow, that scope including all equivalents of the subject matter of the claims.

What is claimed is:

1. A computer-implemented business method for bartering groceries and other goods for silver and gold, comprising:
where the bartering is between (1) a business that (a) SELLS groceries and other goods, and also (b) BARTERS groceries and other goods, and (2) a customer that BARTERS silver and or gold with the business for groceries and other goods;
where the business is a retailer or wholesaler that: (1) SELLS to its customers groceries and other goods for debt-based Federal Reserve Note (FRN) currency, in physical or digital form, or Central Bank Digital Currency (CBDC), or a currency authorized by the United States of America, or its successor, in a SALES TRANSACTION, and (2) BARTERS groceries and other goods for a customer's silver and or gold that is in at least one of the following forms: coin, token, bar, or bill, each made having at least 90-percent silver or gold content, in a BARTER TRANSACTION;
where the customer presents their silver and or gold for barter, inspection and evaluation at the authorized customer service counter of the business;
whereafter inspection and evaluation of the silver and gold by the business, using a computer-implemented program, a BARTER VALUE is determined or redetermined by the business and accepted or rejected by the customer for some or all the customer's silver and or gold;
whereafter acceptance of the BARTER VALUE by the customer, BARTERED VALUE is agreed upon by the business and customer;
where the customer is informed, by the business, that the BARTER VALUE, or BARTERED VALUE is NOT MONEY OR CURRENCY, nor is it exchangeable or refundable for money or currency, but simply is a BARTERED VALUE that can be exchanged for groceries and other goods, at the business, as an intermediate step in the BARTER TRANSACTION;
where the business, using a computer-implemented program, assigns electronically the BARTERED VALUE, as an intermediate step in the BARTER TRANSACTION, to a BARTERED VALUE CARD (BVC), or a BARTERED VALUE TOKEN (BVT), or a BARTERED VALUE MOBILE DEVICE (BVMD), each having a unique identifying code that has been electronically scanned or recorded and assigned to the business' closed-loop electronic communications network system programmed to process BARTER TRANSACTIONS involving BARTERED VALUE, separate or apart from any SALES TRANSACTIONS involving currency or money;
where (1) the BVC is an electronically activated card that is known as a magnetic stripe card, or a mag-stripe card, or a passive transponder card, or a contactless card, or a proximity card, or a RFID card, or a EMV card, or a smart-chip card, or a two-dimensional matrix card, or a UPC card, or a barcode card, or any combination thereof, (2) the BVT is an electronically activated 3-dimensional device known as a RFID token, or passive transponder token, a contactless token, or proximity token, and (3) the BVMD is a customer's electronic smartphone, or smart tablet, or smart watch, where each, BVC, or BVT, or BVMD, having a unique identifying code, and each capable of electronically communicating with the business' closed-loop electronic communications network system programmed to credit or debit BARTERED VALUE assigned to the BVC, or BVT, or BVMD;
where the computer-implemented program is designed so the BARTERED VALUE is NOT exposed to any payment service provider, or bank, or financial institution;
where the business presents the customer with the BVC, or BVT, or BVMD assigned with the BARTERED VALUE, as an intermediate step in the BARTER TRANSACTION; and
whereafter the customer selects, in the present, or in the future, or in the future on-line, groceries and or other goods from the business that issued the BARTERED VALUE, and at checkout the business exchanges or debits BARTERED VALUE from the BVC, or BVT, or BVMD for the selected groceries and other goods, by scanning or reading the BVC, or BVT, or BVMD with an electronic scanner or reader connected to the closed-loop electronic communications network system.

2. A method according to claim 1 where the BVC, or BVT, or BVMD are designed or computer-programed to process on the the business' closed-loop communications network system, separately, both (a) a BARTERED VALUE for a BARTER TRANSACTION, and (b) a currency amount in FRN currency, or CBDC, to pay for SALE TAX.

3. A method according to claim 1 where the BVC, or BVT, or BVMD is specifically coded, or encoded, and or programed to process BARTERED VALUE separate or different from any SALES TRANSACTION involving currency or money.

4. A method according to claim 1 where a BVC, or BVT, or BVMD can be programed to process and identify both SALES TRANSACTION and BARTER TRANSACTION on the same BVC, or BVT, or BVMD.

5. A method according to claim 1 where the computer-implemented program makes an electronic record of the BARTER TRANSACTION consisting of a BARTER TRANSACTION FORM (BTF), or its equivalent, that includes any of the following information: (a) customer name, (b) customer's email address, (c) customer's cellphone number, (d) description and quantity of silver and gold to be bartered and its BARTERED VALUE, (e) any electronic recorded video or photos of the BARTER TRANSACTION including photo of customer's driver license, (e) electronic signature of the customer, (f) unique identification code of BVC or BVT or BVMD, (g) each TRANSACTION involving debiting or crediting of BARTERED VALUE using a BVC, or BVT, or BVMD, (h) correspondence between the business and customer, (i) terms and conditions of the BARTER TRANSACTION, (j) results of evaluation and or inspection of silver and gold, (k), employee name or number handling BARTER TRANSACTION, (1) customer's store location preference (store number) for bartering, (m) customer attesting to or agreeing to: ownership of silver and silver, (n) that silver and gold is bartered for BARTERED VALUE that is NOT currency or money or is refundable or exchangeable for currency or money, (o) that silver and gold will be delivered to the business today or tomorrow, (p) that BARTERED VALUE issued on a BVC, or BVT, or BVMD, can be exchanged for groceries and other goods only from the issuing business, (q) customer agrees to the terms and condition of the BARTER TRANSACTION as specified on the BTF.

6. A method according to claim 5 where there is a slot in the counter top of the authorized customer service counter that corresponds to a slot in the top of the security safe where a labeled bag tagged with the BTF number or barcode containing the bartered silver and gold can be dropped through the slots during the BARTER TRANSACTION without having to open the security safe, and where the computer-implemented program can detect when the security safe has been opened or closed and can activate video or photo recording for record keeping when the safe is opened and closed.

7. A method according to claim 1 where the “technical field” devices used to perform said computer-implemented business method include: (1) electronic communication network, connected to ethernet and/or internet, further connected to (2) business' closed-loop electronic communications network system, including at least one: (a) Central Processing Unit (CPU), (b) computer having at least one special computer-implemented program designed to make said method function according to the dictates of said method, (c) electronic Point-Of Service (POS) device, (d) an electronic printer, (e) an electronic scanner or reader device capable of communicating with an electronically activated BVC, or BVT, or BVMD

8. A method according to claim 1 where the BARTERED VALUE is a numeric, or alphanumeric, or binary code and is NOT a representation of digital currency or money.

9. A method according to claim 1 where said coin, token, bar, or bill is made of platinum with at least 90-percent content.

10. A method according to claim 1 where the business can assign BARTERED VALUE to the customer's electronic MOBILE DEVICE which is a smartphone, or smart tablet, or smart watch”, where the customer has downloaded the business' mobile BARTER APP on their smartphone, or smart tablet, or smart watch, provided by the business, or its authorized affiliate, whereafter downloaded the smartphone, or smart table, or smart watch can function as a BARTERED VALUE MOBILE DEVICE (BVMD) where the business can electronically assign, credit, or debit BARTERED VALUE to or from the customer's smartphone, or smart tablet, or smart watch, having said mobile BARTER APP, using and connecting to the business' closed-loop electronic communications network system.

11. A method according to claim 1 where the BARTERED VALUE is and remains an accounting liability of the business until the BARTERED VALUE is depleted, or until 5 years of non-use of the BARTERED VALUE.

12. A method according to claim 1 where any inspection and or evaluation of the coin(s), token(s), bar(s), bill(s) performed at the customer service counter may include any of the following which is recorded on the BTF, or its equivalent, for a record: visual inspection, weight inspection, terminal sliding velocity inspection, chemical analysis inspection, size inspection, magnetic test inspection, photographic inspection, drop test analysis, acid test analysis, scratch test analysis, ping test analysis, potentiometric analysis, ultrasound analysis, hardness analysis, density test analysis, specific gravity test.

13. A method according to claim 1 where the computer-implemented program keeps track of the profit or loss of each BARTER TRANSACTION relative to what the profit or loss would have been had the BARTER TRANSACTION been done as a SALES TRANSACTION in FRN, or CBDC, currency instead of a BARTER TRANSACTION, in BARTERED VALUE.

14. A method according to claim 1 where the BARTERED VALUE on the business' closed-loop electronic communications network system, is expressed in numeric or alphanumeric or binary code and the word to describe BARTERED VALUE is “BART” in singular form and “BARTS” in plural form, and where on an US International computer keyboard the “BART” is symbolized as the capital key that shows as #which is just left of the capital key showing $.

15. A method according to claim 1 where the BVC or BVT or BVMD, each having an unique identifying code that is distinguishable by the computer-implemented program from any code that an electronically activated card, or token, or mobile device has for a SALES TRANSACTION involving a currency.

16. A method according to claim 1 where the computer-implemented program determines the BARTERED VALUE based upon inventory quantity levels of silver and gold and the type thereof at each store within a given radius of where the customer's preferred store is.

17. A method according to claim 1 where the computer-implemented program keeps track of each individual BARTER TRANSACTION and determines if during the period from initiation to using the BARTERED VALUE by the customer the value of silver and gold has increased, the business can award electronically additional BARTERED VALUE to the BVC, or BVT, or BVMD and notify the customer by email of the additional awarded BARTERED VALUE.

18. A method according to claim 1 where the BARTERED VALUE is only valid at the business that issued the BARTERED VALUE.

19. A method according to claim 1 where the computer-implemented program determines how much the business saved, in interest cost, by NOT having to borrow and pay FRN currency, or CBDC, for the acquired silver and gold that was BARTERED by its customers.

20. A method according to claim 1 where the computer-implemented program determines how much the business saved by acquiring silver and gold through BARTER as opposed to having purchase and equivalent amount in silver and gold, using FRN currency, where the purchase price includes shipping and insurance charges.
